(19) United States
(12) Patent Application Publication
(10) Pub. No.: US 2025/0257498 A1
(43) Pub. Date: Aug. 14, 2025

(54) DIRECT PRODUCTION OF SULFATED CELLULOSE NANOFIBRILS

(71) Applicant: The Regents of the University of California, Oakland, CA (US)

(72) Inventors: You-Lo Hsieh, Oakland, CA (US); Benjamin Pingrey, Oakland, CA (US)

(21) Appl. No.: 18/833,776

(22) PCT Filed: Jan. 31, 2023
(86) PCT No.: PCT/US2023/012040

§ 371 Date: Jul. 26, 2024

Related U.S. Application Data
(60) Provisional application No. 63/305,244, filed on Jan. 31, 2022.
(60) Provisional application No. 63/370,042, filed on Aug. 1, 2022.

(51) Int. Cl. D01F 2/24; C08B 1/00; C08B 5/14; C08L 1/16; D01D 1/02; D01D 5/06

(52) U.S. Cl. CPC D01F 2/24; C08B 1/003; C08B 5/14; C08L 1/16; D01D 1/02; D01D 5/06; C08L 2203/12; D10B 2201/28; D10B 2401/063

(57) ABSTRACT

Disclosed are sulfated cellulose nanofibrils, methods of making sulfated cellulose nanofibrils, and methods of spinning the sulfated cellulose nanofibrils into high-strength fibers. The sulfated cellulose nanofibrils may be formed using a chlorosulfonic acid treatment.

### PRIORITY CLAIM

This application claims priority to U.S. Provisional Application No. 63/305,244, filed on Jan. 31, 2022, and U.S. Provisional Application No. 63/370,042, filed on Aug. 1, 2022, the entire contents and disclosures of which are incorporated herein.

### STATEMENT AS TO RIGHTS TO INVENTIONS MADE UNDER FEDERALLY SPONSORED RESEARCH OR DEVELOPMENT

Not applicable.

### FIELD OF THE INVENTION

The present disclosure relates generally to sulfated cellulose nanofibrils, to methods of making sulfated cellulose nanofibrils, and to methods of spinning the sulfated cellulose nanofibrils into high-strength fibers. In particular, the present disclosure relates to sulfated cellulose nanofibrils, to methods of making sulfated cellulose nanofibrils by using a chlorosulfonic acid treatment, and to methods of wet-spinning the sulfated cellulose nanofibrils into high-strength fibers

### BACKGROUND OF THE INVENTION

Cellulose is the most abundant biopolymer on the planet and has been widely utilized in its native fibrous forms in textiles and paper for millennia. For over a century, dissolved and derivatized cellulose have also enabled processing into fibers and films for additional products and uses. In these cases, the cellulose I crystalline structure is lost and replaced with cellulose II crystalline structure, such as in the case of regenerated cellulose fibers. This change from cellulose I crystalline structure to cellulose II crystalline structure is accompanied by a loss in mechanical strength. Nanocelluloses are the crystalline domains isolated from native cellulose and they therefore retain the cellulose I crystalline structure. Nanocelluloses possess remarkable mechanical properties. For example, hydrolysis by concentrated sulfuric acid removes amorphous cellulose chains, leaving highly crystalline rod-like cellulose nanocrystals (CNCs). Such CNCs have a tensile strength and Young's modulus as high as 7.5 GPa and approximately 150 GPa, respectively, but in low yields.

Towards the other extreme, intense mechanical means can produce thinner and longer cellulose nanofibrils (CNF) in higher yields. To reduce the mechanical energy needed to separate cellulose into CNF, chemical pretreatments may be performed. Among the most reported pretreatments is the regioselective oxidation of cellulose mediated by the aminoxyl radical (2,2,6,6-tetramethylpiperidin-1-yl)oxyl, referred to as TEMPO. This TEMPO treatment is followed by mechanical disintegration to produce carboxylated CNF. TEMPO-oxidized CNF (TCNF) may be produced closer to full yield and are highly dispersible in aqueous media. This makes TCNF attractive for a myriad of applications, including gas membrane, packaging membranes, composites, aerogels, superabsorbent materials, biomedical scaffolds, printed electronics, and energy storage devices.

Translating the ultra-high mechanical strength of nanocelluloses into macroscopic structures, however, remains a significant engineering challenge. For fiber formation, the high aspect ratios and specific surfaces of CNF provide advantages over CNCs. Aligning CNF during processing, however, is challenging yet critical for the bulk materials to inherit the longitudinal strength of the nanofibrils. One proven process for effective alignment of long chain polymers, as with dissolved cellulose and cellulose derivatives, to produce fibers is wet spinning. In wet spinning, the dissolved polymer is extruded into a coagulation bath containing an antisolvent, which causes the polymer to fall out of solution and solidify into a continuous filament. In fact, wet spinning of both TCNF and unmodified CNF has been demonstrated and reviewed.

For wet-spinning CNF, the most reported coagulants have included acetone, ethanol, tetrahydrofuran (THF), and dioxane. Aqueous calcium chloride solutions have also been utilized as coagulants for TCNF with multivalent Ca²⁺ ions screening electrostatic repulsion among the carboxylated nanofibrils to induce aggregation and ionic crosslinking.

To advance nanocelluloses into fibers, scalable reactions and engineering processes are needed. Additional routes to CNF beyond TEMPO are desirable not only to alleviate the high cost of the reagent, but also to expand the diversity of surface chemistries.

### SUMMARY OF THE INVENTION

In some embodiments, the present disclosure is directed to a method for forming sulfated cellulose nanofibrils, the method comprising: a) dispersing cellulose in a solvent to form a cellulose dispersion; b) reacting the dispersed cellulose with chlorosulfonic acid to produce sulfated cellulose; c) washing the sulfated cellulose to form a washed sulfated cellulose; and d) disintegrating the sulfated cellulose to form sulfated cellulose nanofibrils. The cellulose may be Cellulose I or native cellulose isolated from plant biomass such as rice straw, wheat straw, sugarcane, bagasse, almond shell, corn husk, wood, bamboo, jute, hemp, sisal, and/or combinations thereof. The reacting cellulose with chlorosulfonic acid may simultaneously pretreat and functionalize the cellulose. The method may further comprise: e) wet-spinning the sulfated cellulose nanofibrils to form fibers. The method according to claim 4, wherein the wet-spinning is conducted in the presence of a coagulant selected from the group consisting of acetone, ethanol, isopropanol, mixtures of calcium chloride and isopropanol, and combinations thereof. In some aspects, the fibers are not subjected to drawing. The yield of sulfated cellulose nanofibrils may be at least 90%. The molar ratio of chlorosulfonic acid per anhydroglucose unit may be from 0.5:1 to 1.5:1. The reacting may occur for one (1) to sixty (60) minutes, preferably thirty (30) to sixty (60) minutes. The length of the sulfated cellulose nanofibrils may be from 0.7 μm to 1.8 μm. The width of the sulfated cellulose nanofibril may be from 3.5 to 6 nm. The height of the sulfated cellulose nanofibril may be from 1.2 to 1.4 nm. The length to height aspect ratio of the sulfated cellulose nanofibril may be from 500:1 to 1000:1. The sulfated cellulose nanofibril may have a rectangular cross section with a width to height ratio from 3:1 to 4.7:1. The sulfated cellulose nanofibril may exhibit amphiphilicity, thixotropy, and shear thinning behaviors.

In some embodiments, the present disclosure is directed to a wet-spun sulfated cellulose nanofibril fiber. The fiber may be formed by a method comprising: a) dispersing cellulose in a solvent to form a cellulose dispersion; b) reacting the dispersed cellulose with chlorosulfonic acid to produce sulfated cellulose; c) washing the sulfated cellulose to form a washed sulfated cellulose; and d) disintegrating the sulfated cellulose to form sulfated cellulose nanofibrils. The cellulose may be Cellulose I or native cellulose isolated from plant biomass such as rice straw, wheat straw, sugarcane bagasse, almond shell, corn husk, wood, bamboo, jute, hemp, sisal, or combinations thereof. Reacting cellulose with chlorosulfonic acid may simultaneously pretreat and functionalize the cellulose. The method may further comprise: e) wet-spinning the sulfated cellulose nanofibrils to form fibers. The method according to claim 4, wherein the wet-spinning is conducted in the presence of a coagulant selected from the group consisting of acetone, ethanol, isopropanol, mixtures of calcium chloride and isopropanol, and combinations thereof. In some aspects, the fibers are not subjected to drawing. The yield of sulfated cellulose nanofibrils may be at least 90%. The molar ratio of chlorosulfonic acid per anhydroglucose unit may be from 0.5:1 to 1.5:1. The reacting may occur for one (1) to sixty (60) minutes, preferably thirty (30) to sixty (60) minutes. The length of the sulfated cellulose nanofibrils may be from 0.7 μm to 1.8 μm. The width of the sulfated cellulose nanofibril may be from 3.5 to 6 nm. The height of the sulfated cellulose nanofibril may be from 1.2 to 1.4 nm. The length to height aspect ratio of the sulfated cellulose nanofibril may be from 500:1 to 1000:1. The sulfated cellulose nanofibril may have a rectangular cross section with a width to height ratio from 3:1 to 4.7:1. The sulfated cellulose nanofibril may exhibit amphiphilicity, thixotropy, and shear thinning behaviors. The fiber may have a charge from 1.0 mmol/g to 2 mmol/g. The fiber may have a fiber diameter from 9 to 20 μm. The fiber may have a Young's modulus from 20 to 35 GPa. The sulfated cellulose nanofibril may have a tensile strength from 525 to 850 MPa. The sulfated cellulose nanofibril may have a strain at break from 5 to 15%.

### BRIEF DESCRIPTION OF THE DRAWINGS

FIG. 1 illustrates a schematic generation of SCNF from cellulose through a reaction with chlorosulfonic acid followed by high-speed blending, in accordance with embodiments of the invention.

FIG. 2A illustrates the effect of sulfation reaction conditions followed by high-speed blending (30K rpm, 30 min) on surface charge as a function of HSO₃Cl/AGU molar ratio and reaction time, in accordance with embodiments of the invention.

FIG. 2B illustrates the effect of sulfation reaction conditions followed by high-speed blending (30K rpm, 30 min) on SCNF yield as a function of surface charge (30 min blending), in accordance with embodiments of the invention.

FIG. 2C illustrates the effect of sulfation reaction conditions followed by high-speed blending (30K rpm, 30 min) on SCNF with a charge of 1.0 mmol/g, showing some branching fibrils, in accordance with embodiments of the invention.

FIG. 2D illustrates the effect of sulfation reaction conditions followed by high-speed blending (30K rpm, 30 min) on SCNF yield as a function of blending time, in accordance with embodiments of the invention.

FIG. 3A provides characterization of SCNF with a charge of 1.3 mmol/g, in accordance with embodiments of the invention.

FIG. 3b provides characterization of SCNF with a charge of 1.8 mmol/g, in accordance with embodiments of the invention.

FIG. 3C provides characterization of SCNF with a charge of 2.2 mmol/g, in accordance with embodiments of the invention.

FIG. 4A provides FTIR spectra of selected SCNF samples and rice straw cellulose, in accordance with embodiments of the invention.

FIG. 4B provides XRD profiles of selected SCNF samples and rice straw cellulose, in accordance with embodiments of the invention.

FIG. 5A provides aqueous SCNF property of effective viscosities as a function of shear rate, in accordance with embodiments of the invention.

FIG. 5B provides aqueous SCNF property of viscosities as a function of concentration, in accordance with embodiments of the invention.

FIG. 5C provides aqueous SCNF property of surface tension as a function of concentration, in accordance with embodiments of the invention.

FIG. 6 provides cross section models of SNCF with cellulose 1β unit cell and d-spacing indicated, in accordance with embodiments of the invention.

FIG. 7A provides SEM of wet-spun SCNF fibers showing longitudinal images with charge of 1.3 mmol/g and acetone as the coagulant, in accordance with embodiments of the invention.

FIG. 7B provides SEM of wet-spun SCNF fibers showing longitudinal images with charge of 1.3 mmol/g and IPA as the coagulant, in accordance with embodiments of the invention.

FIG. 7C provides SEM of wet-spun SCNF fibers showing longitudinal images with a charge of 1.3 and IPA+0.1% CaCl₂) as the coagulant, in accordance with embodiments of the invention.

FIG. 7D provides SEM of wet-spun SCNF fibers showing longitudinal images with a charge of 1.8 and IPA+0.1% CaCl₂) as the coagulant, in accordance with embodiments of the invention.

FIG. 7E provides SEM of wet-spun SCNF fibers showing longitudinal images with charge of 1.8 and IPA+0.1% CaCl₂) as the coagulant showing the fractured surface of SCNF, in accordance with embodiments of the invention.

FIG. 7F provides SEM of wet-spun SCNF fibers showing longitudinal images with charge of 1.8 and IPA+0.1% CaCl₂ as the coagulant showing the fractured surface of SCNF, in accordance with embodiments of the invention.

FIG. 8A provides the representative stress-strain curves for tensile strength of wet-spun SCNF fibers, in accordance with embodiments of the invention.

FIG. 8B provides a comparison of the tensile strength of wet-spun SCNF fibers with other known wet-spun fibers, in accordance with embodiments of the invention.

FIG. 9 provides representative conductometric titration curve for determining nanofibril charge, in accordance with embodiments of the invention.

FIG. 10 provides AFM and TEM of SCNF along with a summary of SCNF properties, in accordance with embodiments of the invention.

FIG. 11 provides a formulas of doped PEDOT and sulfated cellulose, in accordance with embodiments of the invention.

FIG. 12 shows PEDOT:PSS/SCNF dispersions of varying compositions, in accordance with embodiments of the invention.

FIG. 13 shows viscosity and TGA curves for PEDOT:PSS/SCNF dispersions with varying amounts of SCNF in the anion, in accordance with embodiments of the invention.

FIG. 14 shows AFM and TEM of PEDOT:PSS/SCNF complexes with varying amounts of SCNF in the anion, in accordance with embodiments of the invention.

FIG. 15 shows the conductivity of PEDOT complexes, in accordance with embodiments of the invention.

FIG. 16 shows the results of optical microscopy, in accordance with embodiments of the invention.

### DETAILED DESCRIPTION

The present disclosure methods for forming sulfated cellulose nanofibrils and to the sulfated cellulose nanofibrils produced by the described method. The method may include dispersing cellulose in a solvent to form a cellulose dispersion, reacting the dispersed cellulose with chlorosulfonic acid (HSO₃Cl) to produce sulfated cellulose, washing the sulfated cellulose to form a washed sulfated cellulose, and disintegrating the sulfated cellulose to form sulfated cellulose nanofibrils. In some aspects, the reacting step simultaneously pretreats and functionalizes the cellulose. In further aspects, the sulfated cellulose nanofibrils are not subjected to drawing. In some aspects, the sulfated cellulose nanofibrils may be wet-spun to form fibers.

Sulfation, while well-established for dissolving cellulose to produce regenerated cellulose, is a less-explored alternative to produce anionic CNF. A variety of sulfating agents have been applied to cellulose. Chlorosulfonic acid, which reacts readily with alcohols to give the corresponding alkyl sulfates, may be used to produce water-soluble cellulose sulfates. Performed under milder conditions, reacting nanocelluloses with chlorosulfonic acid has been shown to add sulfate half-ester groups to CNC produced from sulfuric acid hydrolysis and CNF produced by homogenization, giving respective charges of 0.4 mmol/g and 0.56−1.79 mmol/g.

Sulfonated CNF has also been produced by a two-step reaction involving the periodate cleavage of cellulose's 2,3 vicinal diol to produce 2,3-dialdehyde cellulose, followed by reaction with bisulfite and homogenization to a 91% yield with 0.51 mmol/g of hydroxy sulfonate groups. Using a deep eutectic solvent of sulfamic acid and urea at 150° C. in conjunction with microfluidization has also produced 4.4 nm wide sulfated CNF with 1.44−3.00 mmol/g sulfate contents. A possible carbamation side reaction, however, may complicate this process by generating other unintended functional groups. Regardless of the reactions, processes, and cellulose feedstock involved, sulfated cellulose or nanocellulose variants have typically been lauded for their aqueous solubility, dispersibility, and superior absorbent properties imparted by the introduction of hygroscopic sulfate groups. Thus far, sulfated CNF has not been exploited for more diverse functional applications, particularly those building upon the unique intrinsic strength and anisotropy of CNF.

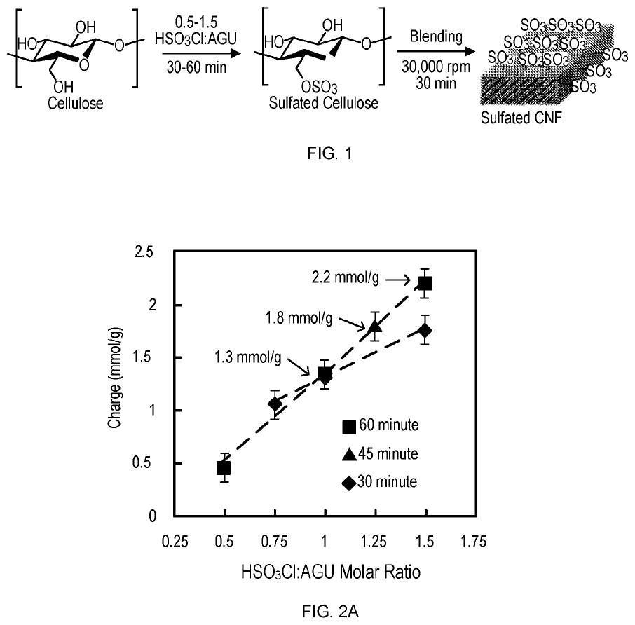

In some embodiments, as shown in FIG. 1, heterogeneous sulfation of cellulose with chlorosulfonic acid (HSO₃Cl) proceeds via bimolecular substitution and the repulsive charge induced by sulfation helps facilitate the disintegration of sulfated cellulose by high-speed blending into aqueously dispersible SCNF. Due to the solubility of cellulose sulfates at higher degrees of substitution, reaction conditions that minimize dissolution while providing sufficient sulfation to disintegrate macroscale sulfated cellulose into SCNF may be used. For example, sulfation of cellulose with HSO₃Cl may exhibit many characteristics typical of SN2 reactions, such as selectivity for primary hydroxyls over secondary and tertiary sites. In this regard, the sulfation of cellulose with chlorosulfonic acid is similar to TEMPO oxidation.

Surprisingly and unexpectedly, the inventors developed a robust and versatile reaction that resulted in yields of over 90%, e.g., over 92%, over 93%, over 94%, over 95%, or over 96%. As described herein, the “one-pot” sulfation of cellulose has not previously been reported and represents an effective path forward for producing sulfated cellulose nanofibrils (SCNF).

In some embodiments, the cellulose may be Cellulose I, also referred to as native cellulose. Cellulose I is the most abundant form of cellulose which occurs mainly in plant cell walls. Cellulose I exists in two distinct allomorphs, la (having a triclinic unit cell) and IP (having a monoclinic cell). In some embodiments, the cellulose may be any native cellulose, such as cellulose isolated from plant biomass, including rice straw, wheat straw, sugarcane, bagasse, almond shell, corn husk, wood, bamboo, jute, hemp, sisal, or combinations thereof. In further embodiments, the cellulose may be isolated from bacteria or animals. In some specific aspects, the cellulose is rice straw cellulose.

The cellulose may be isolated by known methods. including via dewaxing by Soxhlet extraction with a 2:1 volume/volume mixture of refluxing toluene/ethanol, followed by delignification with 1.4 wt % acidified NaClO, and then hemicellulose removal with 5 wt % KOH.

The cellulose may be dispersed in a solvent to form a cellulose dispersion. The solvent is selected to dissolve the cellulose rapidly but minimal degradation. Exemplary solvents include organic solvents, such as dimethylformamide (DMF), N,N-dimethylacetamide (DMAc), dimethyl sulfoxide (DMSO), optionally in the presence of a co-solvent. Once the cellulose is combined with the solvent, it may be stirred, e.g., stirred vigorously, for a period from 1 to 60 minutes, to allow the cellulose to disperse. In some aspects, the cellulose is stirred for 1 to 50 minutes, e.g., from 1 to 45 minutes, from 1 to 30 minutes, from 1 to 20 minutes, or from 1 to 15 minutes.

Following dispersion, the cellulose is then combined with chlorosulfonic acid. In an exemplary process, the chlorosulfonic acid is combined with the organic solvent used to disperse the cellulose, such as DMF. This mixture is then added to the dispersed cellulose to being the reaction. The reaction may be terminated by adding purified water to the dispersed cellulose/chlorosulfonic acid mixture. The sulfated cellulose may then be centrifuged and washed with purified water. Any remaining chlorosulfonic acid and solvent may be removed through dialysis against purified water. This removal may take up to 14 days, e.g., from 1 to 14 days, from 2 to 12 days, from 3 to 10 days, or from 6 to 8 days.

During the reacting step, specific ratios of chlorosulfonic acid per anhydroglucose unit may be selected. These ratios, in combination with short reaction times, have surprisingly and unexpectedly resulted in the yields of over 90%, described herein. The reaction may be conducted at ambient (room) temperature, i.e., 25° C. The SCNF charge may be tuned, e.g., selected, by controlling the ratio and reaction time.

During the reacting step, the ratio of chlorosulfonic acid per anhydroglucose unit may range from 0.5:1 to 1.5:1, e.g., from 0.5:1 to 1.25:1, from 0.5:1 to 1:1, from 1.25:1, or from 1.5:1. In some embodiments, the ratio of chlorosulfonic acid per anhydroglucose unit is about 0.5:1, about 0.6:1, about 0.7:1, about 0.8:1, about 0.9:1, about 1.0:1, about 1.1:1, about 1.2:1, about 1.3:1 about 1.4:1, or about 1.5:1, and all ranges between the cited endpoints.

In some embodiments, reaction times may be about 1 to about 60 min, preferably about 30 to about 60 min, e.g., about 1 min, about 2 min, about 3 min, about 4 min, about 5 min, about 6 min, about 7 min, about 8 min, about 9 min, about 10 min, about 11 min, about 12 min, about 13 min, about 14 min, about 15 min, about 16 min, about 17 min, about 18 min, about 19 min, about 20 min, about 21 min, about 22 min, about 23 min, about 24 min, about 25 min, about 26 min, about 27 min, about 28 min, about 29 min, about 30 min, about 31 min, about 32 min, about 33 min, about 34 min, about 35 min, about 36 min, about 37 min, about 38 min, about 39 min, about 40 min, about 41 min, about 42 min, about 43 min, about 44 min, about 45 min, about 46 min, about 47 min, about 48 min, about 49 min, about 50 min, about 51 min, about 52 min, about 53 min, about 54 min, about 55 min, about 56 min, about 57 min, about 58 min, about 59 min, or about 60 min. All ranges including the above recited end points are also contemplated.

By varying the HSO₃Cl/AGU molar ratio and reaction times within the ranges described herein, sulfated cellulose with charges ranging from 0.45±0.10 to 2.20±0.10 mmol/g may be produced. Without being bound by theory, it is believed that the HSO₃Cl/AGU ratio is the most significant determiner of charge of the sulfated cellulose. Reaction time and other conditions, however, also effect the charge of the sulfated cellulose. For example, longer reaction times may magnify the effect of the HSO₃Cl/AGU ratio.

Once the reaction is terminated as described herein, the sulfated cellulose is washed to form a washed sulfated cellulose. The washed sulfated cellulose may then be disintegrated to form sulfated cellulose nanofibrils.

In some embodiments, the SCNF produced may have tunable charges of 1.0 to 2.2 mmol/g, e.g., may be about 1.0 mmol/g, about 1.1 mmol/g, about 1.2 mmol/g, about 1.3 mmol/g, about 1.4 mmol/g, about 1.5 mmol/g, about 1.6 mmol/g, about 1.7 mmol/g, about 1.8 mmol/g, about 1.9 mmol/g, about 2.0 mmol/g, about 2.1 mmol/g, or about 2.2 mmol/g.

As described herein, the yield of SCNF is at least 90%. This yield may be compared to known high speeding blending of rice straw cellulose without any pretreatment, even for an extended period of 60 minutes, which yields less than 5% nanofibrils. As described herein, the reacting cellulose with chlorosulfonic acid simultaneously pretreats and functionalizes the cellulose, simplifying the method. In some embodiments, reaction conditions described herein demonstrate that blending of sulfated cellulose for as little as 30 minutes dramatically increased nanofibril yields as compared to the known methods.

The sulfated cellulose nanofibrils may be wet-spun to form fibers. The wet-spinning may be conducted in the presence of a coagulant selected from the group consisting of acetone, ethanol, isopropanol, mixtures of calcium chloride and isopropanol, and combinations thereof. In some aspects, the coagulant is a mixture of isopropanol and calcium chloride, wherein the calcium chloride is present in an amount from 0.01 to 15 wt %, e.g., from 0.01 to 10 wt %, from 0.01 to 5 wt %, from 0.05 to 2.5 wt %, from 0.05 to 1 wt %, from 0.05 to 0.5 wt %, or from 0.05 to 0.15 wt %, based on the total amount of coagulant used. In some aspects, during wet-spinning, the fibers are not subjected to a drawing step.

SCNF may be characterized via AFM, TEM, FTIR, and XRD. In some embodiments, the average SCNF length (L) may decrease with increasing levels of sulfation from 1.3 mmol/g to 1.8 mmol/g and 2.2 mmol/g. A progressive reduction in fibril width (W) may also be observed with increasing sulfation. The height (H) values of all SCNF may have little variation between reaction conditions. In some embodiments, the L/H aspect ratios of SCNF were high, though they showed a downward trend with increasing sulfation. Based on the H values from AFM and W values from TEM, SCNF may have rectangular cross sections (W/H ratios).

For example, SCNF lengths (L) may be about 0.7 to about 1.8 μm, e.g., about 0.7 μm, about 0.8 μm, about 0.9 μm, about 1.0 μm, about 1.1 μm, about 1.2 μm, about 1.3 μm, about 1.4 μm, about 1.5 μm, about 1.6 μm, about 1.7 μm, or about 1.8 μm. All ranges including the above recited end points are also contemplated.

For example, SCNF widths (W) may be about 3.5 to about 6.0 nm, e.g., about 3.5 nm, about 3.6 nm, about 3.7 nm, about 3.8 nm, 3.9 nm, about 4.0 nm, about 4.1 nm, about 4.2 nm, about 4.3 nm, about 4.4 nm, about 4.5 nm, about 4.6 nm, about 4.7 nm, about 4.8 nm, about 4.9 nm, about 5.0 nm, about 5.1 nm, about 5.2 nm, about 5.3 nm, about 5.4 nm, about 5.5 nm, about 5.6 nm, about 5.7 nm, about 5.8 nm, about 5.9 nm, or about 6.0 nm. All ranges including the above recited end points are also contemplated.

For example, SCNF heights (H) may be about 1.2 to about 1.4 nm, e.g., about 1.2 nm, about 1.3 nm, or about 1.4 nm. All ranges including the above recited end points are also contemplated.

For example, the length to height aspect ratio (L:H) may be about 500:1 to about 1000:1, e.g., about 500:1, about 501:1, about 502:1, about 503:1, about 504:1, about 505:1, about 506:1, about 507:1, about 508:1, about 509:1, about 510:1, about 511:1, about 512:1, about 513:1, about 514:1, about 515:1, about 516:1, about 517:1, about 518:1, about 519:1, about 520:1, about 521:1, about 522:1, about 523:1, about 524:1, about 525:1, about 526:1, about 527:1, about 528:1, about 529:1, about 530:1, about 531:1, about 532:1, about 533:1, about 534:1, about 535:1, about 536:1, about 537:1, about 538:1, about 539:1, about 540:1, about 541:1, about 542:1, about 543:1, about 544:1, about 545:1, about 546:1, about 547:1, about 548:1, about 549:1, about 550:1, about 551:1, about 552:1, about 553:1, about 554:1, about 555:1, about 556:1, about 557:1, about 558:1, about 559:1, about 560:1, about 561:1, about 562:1, about 563:1, about 564:1, about 565:1, about 566:1, about 567:1, about 568:1, about 569:1, about 570:1, about 571:1, about 572:1, about 573:1, about 574:1, about 575:1, about 576:1, about 577:1, about 578:1, about 579:1, about 580:1, about 581:1, about 582:1, about 583:1, about 584:1, about 585:1, about 586:1, about 587:1, about 588:1, about 589:1, about 590:1, about 591:1, about 592:1, about 593:1, about 594:1, about 595:1, about 596:1, about 597:1, about 598:1, about 599:1, about 600:1, about 601:1, about 602:1, about 603:1, about 604:1, about 605:1, about 606:1, about 607:1, about 608:1, about 609:1, about 610:1, about 611:1, about 612:1, about 613:1, about 614:1, about 615:1, about 616:1, about 617:1, about 618:1, about 619:1, about 620:1, about 621:1, about 622:1, about 623:1, about 624:1, about 625:1, about 626:1, about 627:1, about 628:1, about 629:1, about 630:1, about 631:1, about 632:1, about 633:1, about 634:1, about 635:1, about 636:1, about 637:1, about 638:1, about 639:1, about 640:1, about 641:1, about 642:1, about 643:1, about 644:1, about 645:1, about 646:1, about 647:1, about 648:1, about 649:1, about 650:1, about 651:1, about 652:1, about 653:1, about 654:1, about 655:1, about 656:1, about 657:1, about 658:1, about 659:1, about 660:1, about 661:1, about 662:1, about 663:1, about 664:1, about 665:1, about 666:1, about 667:1, about 668:1, about 669:1, about 670:1, about 671:1, about 672:1, about 673:1, about 674:1, about 675:1, about 676:1, about 677:1, about 678:1, about 679:1, about 680:1, about 681:1, about 682:1, about 683:1, about 684:1, about 685:1, about 686:1, about 687:1, about 688:1, about 689:1, about 690:1, about 691:1, about 692:1, about 693:1, about 694:1, about 695:1, about 696:1, about 697:1, about 698:1, about 699:1, about 700:1, about 701:1, about 702:1, about 703:1, about 704:1, about 705:1, about 706:1, about 707:1, about 708:1, about 709:1, about 710:1, about 711:1, about 712:1, about 713:1, about 714:1, about 715:1, about 716:1, about 717:1, about 718:1, about 719:1, about 720:1, about 721:1, about 722:1, about 723:1, about 724:1, about 725:1, about 726:1, about 727:1, about 728:1, about 729:1, about 730:1, about 731:1, about 732:1, about 733:1, about 734:1, about 735:1, about 736:1, about 737:1, about 738:1, about 739:1, about 740:1, about 741:1, about 742:1, about 743:1, about 744:1, about 745:1, about 746:1, about 747:1, about 748:1, about 749:1, about 750:1, about 751:1, about 752:1, about 753:1, about 754:1, about 755:1, about 756:1, about 757:1, about 758:1, about 759:1, about 760:1, about 761:1, about 762:1, about 763:1, about 764:1, about 765:1, about 766:1, about 767:1, about 768:1, about 769:1, about 770:1, about 771:1, about 772:1, about 773:1, about 774:1, about 775:1, about 776:1, about 777:1, about 778:1, about 779:1, about 780:1, about 781:1, about 782:1, about 783:1, about 784:1, about 785:1, about 786:1, about 787:1, about 788:1, about 789:1, about 790:1, about 791:1, about 792:1, about 793:1, about 794:1, about 795:1, about 796:1, about 797:1, about 798:1, about 799:1, about 800:1, about 801:1, about 802:1, about 803:1, about 804:1, about 805:1, about 806:1, about 807:1, about 808:1, about 809:1, about 810:1, about 811:1, about 812:1, about 813:1, about 814:1, about 815:1, about 816:1, about 817:1, about 818:1, about 819:1, about 820:1, about 821:1, about 822:1, about 823:1, about 824:1, about 825:1, about 826:1, about 827:1, about 828:1, about 829:1, about 830:1, about 831:1, about 832:1, about 833:1, about 834:1, about 835:1, about 836:1, about 837:1, about 838:1, about 839:1, about 840:1, about 841:1, about 842:1, about 843:1, about 844:1, about 845:1, about 846:1, about 847:1, about 848:1, about 849:1, about 850:1, about 851:1, about 852:1, about 853:1, about 854:1, about 855:1, about 856:1, about 857:1, about 858:1, about 859:1, about 860:1, about 861:1, about 862:1, about 863:1, about 864:1, about 865:1, about 866:1, about 867:1, about 868:1, about 869:1, about 870:1, about 871:1, about 872:1, about 873:1, about 874:1, about 875:1, about 876:1, about 877:1, about 878:1, about 879:1, about 880:1, about 881:1, about 882:1, about 883:1, about 884:1, about 885:1, about 886:1, about 887:1, about 888:1, about 889:1, about 890:1, about 891:1, about 892:1, about 893:1, about 894:1, about 895:1, about 896:1, about 897:1, about 898:1, about 899:1, about 900:1, about 901:1, about 902:1, about 903:1, about 904:1, about 905:1, about 906:1, about 907:1, about 908:1, about 909:1, about 910:1, about 911:1, about 912:1, about 913:1, about 914:1, about 915:1, about 916:1, about 917:1, about 918:1, about 919:1, about 920:1, about 921:1, about 922:1, about 923:1, about 924:1, about 925:1, about 926:1, about 927:1, about 928:1, about 929:1, about 930:1, about 931:1, about 932:1, about 933:1, about 934:1, about 935:1, about 936:1, about 937:1, about 938:1, about 939:1, about 940:1, about 941:1, about 942:1, about 943:1, about 944:1, about 945:1, about 946:1, about 947:1, about 948:1, about 949:1, about 950:1, about 951:1, about 952:1, about 953:1, about 954:1, about 955:1, about 956:1, about 957:1, about 958:1, about 959:1, about 960:1, about 961:1, about 962:1, about 963:1, about 964:1, about 965:1, about 966:1, about 967:1, about 968:1, about 969:1, about 970:1, about 971:1, about 972:1, about 973:1, about 974:1, about 975:1, about 976:1, about 977:1, about 978:1, about 979:1, about 980:1, about 981:1, about 982:1, about 983:1, about 984:1, about 985:1, about 986:1, about 987:1, about 988:1, about 989:1, about 990:1, about 991:1, about 992:1, about 993:1, about 994:1, about 995:1, about 996:1, about 997:1, about 998:1, about 999:1, or about 1000:1.

In some embodiments, the SCNF had uniquely anisotropic cross-sections (W:H) and high aspect ratios (L:H) while also exhibiting amphiphilicity, thixotropy, and shear thinning behaviors that closely followed a power law model. For example, anisotropic cross-sections width to height ratio (W:H) may be about 3.0:1 to about 4.7:1, e.g., about 3.0:1, about 3.1:1, about 3.2:1, about 3.3:1, about 3.4:1, about 3.5:1, about 3.6:1, about 3.7:1, about 3.8:1, about 3.9:1, about 4.0:1, about 4.1:1, about 4.2:1, about 4.3:1, about 4.4:1, about 4.5:1, about 4.6:1, or about 4.7:1. All ranges including the above recited end points are also contemplated.

For example, the sulfated cellulose nanofibril may have a rectangular cross section with a width to height ratio from about 3:1 to about 4.7:1, e.g., about 3:1, about 3.1:1, about 3.2:1, about 3.3:1, about 3.4:1, about 3.5:1, about 3.6:1, about 3.7:1, about 3.8:1, about 3.9:1, about 4:1, about 4.1:1, about 4.2:1, about 4.3:1, about 4.4:1, about 4.5:1, about 4.6:1, or about 4.7:1. All ranges including the above recited end points are also contemplated.

For example, the fibers tensile strength may be about 525 to about 850 MPa, e.g., about 525 MPa, about 526 MPa, about 527 MPa, about 528 MPa, about 529 MPa, about 530 MPa, about 531 MPa, about 532 MPa, about 533 MPa, about 534 MPa, about 535 MPa, about 536 MPa, about 537 MPa, about 538 MPa, about 539 MPa, about 540 MPa, about 541 MPa, about 542 MPa, about 543 MPa, about 544 MPa, about 545 MPa, about 546 MPa, about 547 MPa, about 548 MPa, about 549 MPa, about 550 MPa, about 551 MPa, about 552 MPa, about 553 MPa, about 554 MPa, about 555 MPa, about 556 MPa, about 557 MPa, about 558 MPa, about 559 MPa, about 560 MPa, about 561 MPa, about 562 MPa, about 563 MPa, about 564 MPa, about 565 MPa, about 566 MPa, about 567 MPa, about 568 MPa, about 569 MPa, about 570 MPa, about 571 MPa, about 572 MPa, about 573 MPa, about 574 MPa, about 575 MPa, about 576 MPa, about 577 MPa, about 578 MPa, about 579 MPa, about 580 MPa, about 581 MPa, about 582 MPa, about 583 MPa, about 584 MPa, about 585 MPa, about 586 MPa, about 587 MPa, about 588 MPa, about 589 MPa, about 590 MPa, about 591 MPa, about 592 MPa, about 593 MPa, about 594 MPa, about 595 MPa, about 596 MPa, about 597 MPa, about 598 MPa, about 599 MPa, about 600 MPa, about 601 MPa, about 602 MPa, about 603 MPa, about 604 MPa, about 605 MPa, about 606 MPa, about 607 MPa, about 608 MPa, about 609 MPa, about 610 MPa, about 611 MPa, about 612 MPa, about 613 MPa, about 614 MPa, about 615 MPa, about 616 MPa, about 617 MPa, about 618 MPa, about 619 MPa, about 620 MPa, about 621 MPa, about 622 MPa, about 623 MPa, about 624 MPa, about 625 MPa, about 626 MPa, about 627 MPa, about 628 MPa, about 629 MPa, about 630 MPa, about 631 MPa, about 632 MPa, about 633 MPa, about 634 MPa, about 635 MPa, about 636 MPa, about 637 MPa, about 638 MPa, about 639 MPa, about 640 MPa, about 641 MPa, about 642 MPa, about 643 MPa, about 644 MPa, about 645 MPa, about 646 MPa, about 647 MPa, about 648 MPa, about 649 MPa, about 650 MPa, about 651 MPa, about 652 MPa, about 653 MPa, about 654 MPa, about 655 MPa, about 656 MPa, about 657 MPa, about 658 MPa, about 659 MPa, about 660 MPa, about 661 MPa, about 662 MPa, about 663 MPa, about 664 MPa, about 665 MPa, about 666 MPa, about 667 MPa, about 668 MPa, about 669 MPa, about 670 MPa, about 671 MPa, about 672 MPa, about 673 MPa, about 674 MPa, about 675 MPa, about 676 MPa, about 677 MPa, about 678 MPa, about 679 MPa, about 680 MPa, about 681 MPa, about 682 MPa, about 683 MPa, about 684 MPa, about 685 MPa, about 686 MPa, about 687 MPa, about 688 MPa, about 689 MPa, about 690 MPa, about 691 MPa, about 692 MPa, about 693 MPa, about 694 MPa, about 695 MPa, about 696 MPa, about 697 MPa, about 698 MPa, about 699 MPa, about 700 MPa, about 701 MPa, about 702 MPa, about 703 MPa, about 704 MPa, about 705 MPa, about 706 MPa, about 707 MPa, about 708 MPa, about 709 MPa, about 710 MPa, about 711 MPa, about 712 MPa, about 713 MPa, about 714 MPa, about 715 MPa, about 716 MPa, about 717 MPa, about 718 MPa, about 719 MPa, about 720 MPa, about 721 MPa, about 722 MPa, about 723 MPa, about 724 MPa, about 725 MPa, about 726 MPa, about 727 MPa, about 728 MPa, about 729 MPa, about 730 MPa, about 731 MPa, about 732 MPa, about 733 MPa, about 734 MPa, about 735 MPa, about 736 MPa, about 737 MPa, about 738 MPa, about 739 MPa, about 740 MPa, about 741 MPa, about 742 MPa, about 743 MPa, about 744 MPa, about 745 MPa, about 746 MPa, about 747 MPa, about 748 MPa, about 749 MPa, about 750 MPa, about 751 MPa, about 752 MPa, about 753 MPa, about 754 MPa, about 755 MPa, about 756 MPa, about 757 MPa, about 758 MPa, about 759 MPa, about 760 MPa, about 761 MPa, about 762 MPa, about 763 MPa, about 764 MPa, about 765 MPa, about 766 MPa, about 767 MPa, about 768 MPa, about 769 MPa, about 770 MPa, about 771 MPa, about 772 MPa, about 773 MPa, about 774 MPa, about 775 MPa, about 776 MPa, about 777 MPa, about 778 MPa, about 779 MPa, about 780 MPa, about 781 MPa, about 782 MPa, about 783 MPa, about 784 MPa, about 785 MPa, about 786 MPa, about 787 MPa, about 788 MPa, about 789 MPa, about 790 MPa, about 791 MPa, about 792 MPa, about 793 MPa, about 794 MPa, about 795 MPa, about 796 MPa, about 797 MPa, about 798 MPa, about 799 MPa, about 800 MPa, about 801 MPa, about 802 MPa, about 803 MPa, about 804 MPa, about 805 MPa, about 806 MPa, about 807 MPa, about 808 MPa, about 809 MPa, about 810 MPa, about 811 MPa, about 812 MPa, about 813 MPa, about 814 MPa, about 815 MPa, about 816 MPa, about 817 MPa, about 818 MPa, about 819 MPa, about 820 MPa, about 821 MPa, about 822 MPa, about 823 MPa, about 824 MPa, about 825 MPa, about 826 MPa, about 827 MPa, about 828 MPa, about 829 MPa, about 830 MPa, about 831 MPa, about 832 MPa, about 833 MPa, about 834 MPa, about 835 MPa, about 836 MPa, about 837 MPa, about 838 MPa, about 839 MPa, about 840 MPa, about 841 MPa, about 842 MPa, about 843 MPa, about 844 MPa, about 845 MPa, about 846 MPa, about 847 MPa, about 848 MPa, about 849 MPa, or about 850 MPa. All ranges including the above recited end points are also contemplated.

In some embodiments, when aqueous SCNF dispersions are wet-spun into organic and mixed organic/ionic coagulants, the produced continuous fibers may posses an impressively high tensile strength and Young's modulus.

For example, the fibers Young's modulus may be from about 20 to about 35 GPa, e.g., about 20 GPa, about 21 GPa, about 22 GPa, about 23 GPa, about 24 GPa, about 25 GPa, about 26 GPa, about 27 GPa, about 28 GPa, about 29 GPa, about 30 GPa, about 31 GPa, about 32 GPa, about 33 GPa, about 34 GPa, or about 35 GPa.

For example, the wet-spun sulfated cellulose nanofibril fiber may have a charge from about 1.0 mmol/g to about 2.0 mmol/g, e.g., about 1.0 mmol/g, about 1.1 mmol/g, about 1.2 mmol/g, about 1.3 mmol/g, about 1.4 mmol/g, about 1.5 mmol/g, about 1.6 mmol/g, about 1.7 mmol/g, about 1.8 mmol/g, about 1.9 mmol/g, or about 2.0 mmol/g. All ranges including the above recited end points are also contemplated.

For example, a wet-spun sulfated cellulose nanofibril fiber may have a diameter from about 9 to about 20 μm, e.g., about 9 μm, about 10 μm, about 11 μm, about 12 μm, about 13 μm, about 14 μm, about 15 μm, about 16 μm, about 17 μm, about 18 μm, about 19 μm, or about 20 μm. All ranges including the above recited end points are also contemplated.

For example, the wet-spun sulfated cellulose nanofibril fiber may have a strain at break from about 5 to about 15%, e.g., about 5%, about 6%, about 7%, about 8%, about 9%, about 10%, about 11%, about 12%, about 13%, about 14%, or about 15%. All ranges including the above recited end points are also contemplated.

Hybrid Polyelectrolyte Complexes of PEDOT with PSS and Sulfated Cellulose Nanofibrils Through In-Situ Polymerization

For years research into conducting polymers has focused on improving the performance of poly(3,4-ethylenedioxythophene) (PEDOT) and its aqueous dispersions with poly(styrenesulfonate) (PSS). This paper reports the creation of aqueous dispersible PEDOT in hybrid polyelectrolyte complexes by polymerizing EDOT in the presence of sulfated cellulose nanofibrils (SCNF) produced from dissolving pulp through direct sulfation with chlorosulfonic acid in anhydrous N,N-dimethylformamide (DMF). PEDOT synthesized with 30% SCNF along with PSS polyanion led to a nearly threefold increase in conductivity over that with only PSS to 0.14 S/cm. With secondary doping with ethylene glycol (EG), PEDOT synthesized with 10% SCNF with PSS polyanion led to films with a over two order magnitude increase in conductivity to 37.5 S/cm, 58% higher than for EG treated PEDOT synthesized with PSS alone. PEDOT:PSS/SCNF complexes could be dispersed by any combination of PSS and SCNF with PEDOT fractions up to 50 wt %, though no substantial benefit was found when increasing the amount of PEDOT in dispersions beyond the commonly reported 29 wt %.

Poly(3,4-ethylene dioxythiophene) (PEDOT) is a 3,4-disubstituted polythiophene conducting polymer. Since its initial discovery by Bayer AG in 1988,¹ PEDOT has attracted intensive attention for research from both academia and industry and has gained a significant degree of commercial success. A number of factors differentiate PEDOT from other intrinsically conducting polymers. The EDOT monomer is less toxic and volatile than pyrrole—the precursor to polypyrrole-facilitating safer manufacturing.² PEDOT exhibits stable conductivity up to temperatures of 280° C., above the temperatures needed when using lead free solder and significantly higher than the stable range for polypyrrole and polyaniline.² This allows PEDOT to be incorporated into components such as electrolytic capacitors without risking thermal degradation due to soldering.³

Another major aspect of PEDOT is its ability to form aqueous dispersible and stable polyelectrolyte complexes, which facilitates processing. PEDOT is insoluble in any known solvent, meaning that processing the polymer is difficult, often requiring direct chemical or electrochemical polymerization onto a surface. However, this issue was circumvented with the discovery that PEDOT can be polymerized in the presence of a host polyelectrolyte, typically poly(styrene sulfonate) (PSS), to form stable aqueous dispersions. In these PEDOT:PSS polyelectrolyte complexes, positive charges formed during oxidation of the PEDOT chain-analogous to p-type doping in traditional semiconductors—are electrostatically bound to the anionic sulfonate groups in PSS.² These dispersions are attractive from an engineering point of view because they allow PEDOT be processed using a myriad of well-established solution-based techniques including spin coating,⁴ doctor blading,⁵ dip coating,⁶ drop casting,⁷ ink-jetting,⁸ and wet spinning.⁹ However, it must be noted that the inclusion of a significant fraction of insulating PSS (commonly ˜71 wt %, corresponding to PEDOT:PSS mass ratio of 1:2.5) into the PEDOT:PSS matrix has a profound effect on the resulting conductivity.

Various strategies have been implemented to improve the performance of PEDOT:PSS, maintaining both high conductivity and dispersibility. The most prolific is the use of so-called secondary dopants¹⁰ or conductivity enhancement agents.² These are chemicals commonly high boiling point solvents, such as dimethyl sulfoxide (DMSO) or ethylene glycol (EG)—which are added to PEDOT:PSS dispersions prior to processing and are often (but not always^{11,12}) removed from the final product during curing.¹³ In truth, the term secondary dopant, while widely used, is somewhat of a misnomer. In traditional semiconductors, doping refers to the inclusion of foreign atoms into a lattice to bring about a change in electrical structure. In conducting polymers, doping generally refers to redox reactions that bring about positive or negative charges along the polymeric chain.² The species created in these redox reactions-predominantly bipolarons in the case of PEDOT—lead to additional valid energy levels in the band gap of the polymer that lead to dramatically increased conductivity.¹⁴ In PEDOT:PSS, secondary dopants bring about no such oxidative change and, in many cases, aren't even present in the final material; it is therefore somewhat misleading to refer to the process as doping. Despite this fact, the use of secondary dopants is known to bring about drastic increases in conductivity, as large as 2−3 order of magnitude.¹³ The exact mechanism of this enhancement has been a topic of great debate. One school of thought was that the enhancement was the result of small amounts of the secondary dopant remaining in the film and screening interactions between PEDOT and PSS with their polar moieties.¹⁵ Another postulated that the additives acted as plasticizers, facilitating PEDOT to reorganize into higher order that led to higher conductivities.¹⁶ Other explanations include the washing away of the non-conductive PSS during secondary doping¹⁷ and a conformational change in PEDOT from a benzoid to a planar quinoid structure whose conjugated backbone is favored for higher conductivity.¹⁸

Another method that has been examined for improving the conductivity of PEDOT dispersions is by manipulating the morphology of PEDOT:PSS materials through templating. PEDOT:PSS complexes are inherently heterogeneous materials whose conductivity depends as much on ordering and supramolecular structure of both PEDOT and PSS as it does on factors like degree of polymerization or doping level. It has been shown that the inclusion of cellulose nanofibrils (CNF), 1D nanomaterials formed by breaking down cellulose through a combination of chemical and mechanical treatments,¹⁹ into a PEDOT:PSS matrix can lead to the orientation of PEDOT along the nanofibril chains, accompanies by changes in PEDOT crystal structure and conductivity.²⁰ This effect has been shown to lead to a 2-fold increase in bulk conductivity, despite the fact that the insulating CNF dilutes the overall fraction of conducting PEDOT present.²¹ While these works proceeded by mixing premade PEDOT:PSS dispersions with CNF, the fact that many CNF are functionalized with anionic moieties leads to a second option: the in-situ polymerization of PEDOT in the direct presence of an anionic CNF to form dispersible complexes, cutting PSS out of the system entirely. It has been demonstrated that stable aqueous dispersions can be formed by polymerizing PEDOT in the presence of sulfated cellulose nanofibrils (SCNF) produced through sulfamic acid treatment.²² Notably, these dispersions remained stable even at relatively high concentrations of PEDOT up to 50 wt %. This was attributed to the unfunctionalized hydroxyl groups of cellulose aiding in dispersion. Despite these preliminary successes, work in this area is still limited, with many questions persisting about the behavior and properties of systems in which PEDOT is complexed with nanocelluloses.

Sulfated cellulose nanofibrils (SCNF) were produced from dissolving pulp by a previously established method through the use of chlorosulfonic acid treatment in N,N-dimethylformamide (DMF) followed by mechanical blending.²³ EDOT was polymerized into PEDOT in the presence of SCNF and PSS in varying ratios. Dispersion stability, morphology, and conductivity are examined as functions of dispersion anion composition. The effect of secondary doping with EG and DMSO on PEDOT:SCNF and hybrid PEDOT:PSS:SCNF systems is examined with the goal of maximizing dispersion conductivity.

As demonstrated in the examples below, SCNF with 1.81 mmol/g charge was capable of replacing up to 100% PSS in the synthesis of conducting polymer PEDOT. Aqueous dispersibility and conductivity of PEDOT synthesized varied with both PSS/SCNF polyanion:PEDOT cation ratios and SCNF contents. The conductivity of film from PEDOT synthesized with 30% SCNF in the PSS/SCNF polyanion mixture increased by up to threefold. The ethylene glycol doping increased the conductivity of films from PEDOT synthesized with 10% SCNF along with PSS polyanions by more than two order of magnitude to 37.5 S/cm that is 58% higher than doped PEDOT synthesized with PSS alone. Aqueous PEDOT:SCNF/PSS dispersions exhibited much improved shear thinning behaviors. This has ramifications for more processing options including those require higher viscosity.

The present disclosure will be better understood in view of the following non-limiting examples.

### EXAMPLES

### Materials for Examples 1−6

Sodium hydroxide (NaOH, 97.0%), toluene (99.9%), hydrochloric acid (HCl, 1.0 M), and Dowex Marathon C (H-form) acidic ion exchange resin beads were obtained from Fisher Scientific. Reagent grade ethanol, calcium chloride (CaCl₂), 99%), potassium bromide (KBr, 99%), and anhydrous N,N-dimethylformamide (DMF) was obtained from Sigma Aldrich. Chlorosulfonic acid (HSO₃Cl, 99%), toluene (99.5%) and sodium chlorite (NaClO₂, 80% purity) were obtained from Alfa Aesar. Potassium hydroxide (KOH, 85%) was obtained from Acros. Reagent grade isopropanol (IPA) and acetone were obtained from Spectrum Chemicals. Purified water was obtained from a Milli-q Advantage A10 water purification system. All dialysis steps were performed using regenerated cellulose dialysis tubing with a nominal molecular weight cutoff of about 12 to about 14 kDa which were obtained from Fisher Scientific. All chemicals were used as received without further purification.

Cellulose was isolated from Calrose variety rice straw using the procedure described in Lu, P.; Hsieh, Y. -L. Preparation and Characterization of Cellulose Nanocrystals from Rice Straw. Carbohydr. Polm. 2012, 87(1), 564−573. Dewaxing was then conducted by Soxhlet extraction with a 2:1 v/v mixture of refluxing toluene/ethanol, delignification with 1.4 wt % acidified NaClO, and hemicellulose removal with 5 wt % KOH.

### Experimental Methods for Examples 1−6

### Sulfation of Cellulose via Chlorosulfonic Acid.

Cellulose and all glassware used were oven dried prior to use to eliminate moisture. For a typical sulfation run, 0.5 g of cellulose was placed in a stoppered 50 mL Erlenmeyer flask to which 22 mL of anhydrous DMF were added. The mixture was allowed to stir vigorously for a period of approximately 10 min to allow the cellulose to disperse. Chlorosulfonic acid in varied quantities of 0.10−0.31 mL, or 0.5 to 1.5 HSO₃Cl per anhydroglucose unit (AGU) molar ratios, was added dropwise to 3 mL of anhydrous DMF chilled in an ice bath. This HSO₃Cl/DMF mixture was then added to cellulose/DMF to begin the reaction. All reactions were performed at ambient temperature (25° C.) for about 30 to about 60 min. Termination was carried out by the addition of 10 mL purified water. The sulfated cellulose was centrifuged and washed with purified water. Remaining acid and DMF were removed through dialysis against purified water for approximately seven days, until no change in the conductivity of the water was observed.

Defibrillation into SCNF.

Following dialysis, the sulfated cellulose was dispersed at a concentration of 0.2 wt % in 250 mL of purified water and blended at 30,000 rpm in a high-speed blender (Vitamix 5200) for a total of about 30 min in about 5-minute increments to avoid overheating. The aqueous suspension was then centrifuged (Eppendorf 5804R, 5,000 rpm, 15 min) to separate out large fragments that did not defibrillate. A known volume of supernatant and the precipitate were oven dried in tared vessels to determine their mass and concentration, respectively. The wt % of the product that remained dispersed in the supernatant relative to the original sulfated cellulose was reported as the SCNF yield. SCNF Characterization.

The height and length of SCNF were determined through atomic forcemicroscopy (AFM) (Asylum Research MFP-3D) using OMCL-AC160TS standard silicon probes (nominal tip radius of 7 nm, spring constant of 26 N/m). Several drops of diluted SCNF dispersion (ca. 0.0001 wt %) were deposited on freshly cleaved mica discs and allowed to dry. Surface profiles were collected in tapping mode under ambient conditions and processed using the open-source software programs Gwyddion and ImageJ to derive the fibril heights and lengths. For height determination 140+ fibrils were measured while for length 100+ were used, spread across multiple AFM images. Aggregates, where individual fibers could not be differentiated, were excluded from length analysis.

SCNF widths were determined using transmission electron microscopy (TEM) (JEOL JSM-1230). Samples were prepared by placing a drop of diluted SCNF dispersion (ca. 0.0001 wt %) on a glow-discharged carbon grid and blotting away the excess after about 10 min. Samples were negatively stained with 2 wt % uranyl acetate to enhance contrast. Micrographs were taken with a LaB6 electron source using an accelerating voltage of 100 kV. Analysis was performed using ImageJ.

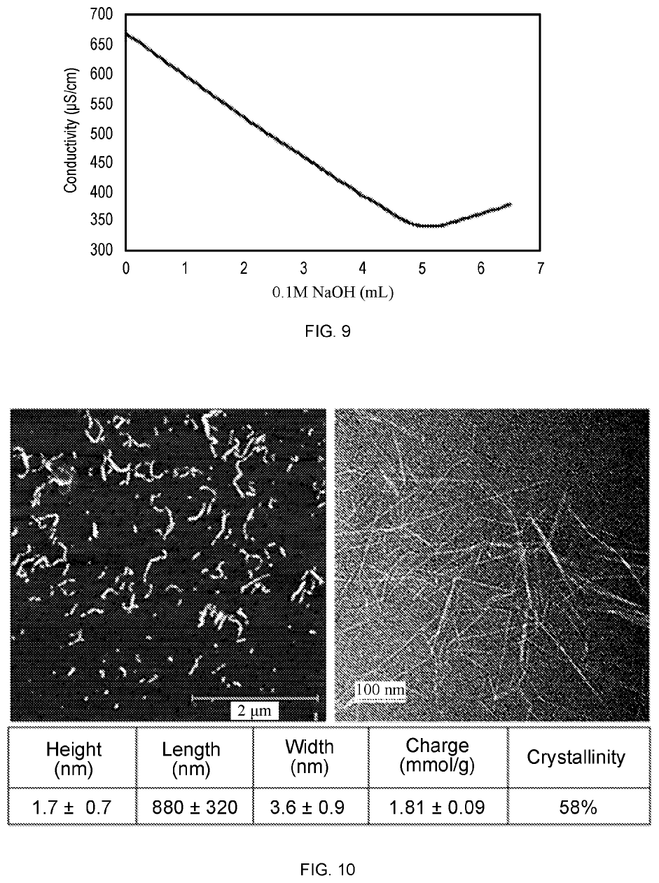

The surface charges of SCNF samples were determined by conductometric titration. To obtain pristine CNF for titration, aliquots of SCNF were dialyzed against purified water for several days to remove small-molecule contaminants. They were then run through an ion exchange column packed with an acidic ion exchange resin (Dowex marathon C, H-form) that exchanges metallic cations for protons to ensure the sulfate half-ester groups on the SCNF were in their acid forms. The SCNF samples (50 mL, diluted to ca. 0.05 wt %) were titrated with 0.01 M sodium hydroxide while measuring the conductivity using a pH meter (Oakton pH/CON 510). A representative titration curve is provided in FIG. 9.

Fourier transform infrared spectroscopy (FTIR) was performed using a Thermo-Nicolet 6700 infrared spectrometer. Aqueous SCNF samples were freeze-dried and then mixed with ground potassium bromide and pressed into pellets. Spectra were collected in transmittance mode from an accumulation of 64 scans at a resolution of 2 cm·1 over the range of 4000−400 cm-X-ray powder diffraction was carried out on a Bruker D8 Advance Eco diffractometer with a CuKα x-ray source. Powdered cellulose and air-dried SCNF samples were scanned at 28 values ranging from 5°-40° with an angular increment of 0.015° and scan time of 0.5s per increment. The crystallinity of cellulose samples was estimated using both the Segal method and a peak deconvolution using 4 crystalline peaks and the fitting software Fityk. Voigt functions were used to model the shape of XRD peaks.

### Aqueous SCNF Dispersion Properties.

The surface tensions of SCNF dispersions were measured on a Kruss K100 tensiometer using the Wilhelmy plate method. The viscosities of aqueous SCNF dispersions were measured using a Brookfield DV3T rheometer with a concentric cylinder geometry. Samples of SCNF with charges of 1.3, 1.8, and 2.2 mmol/g were degassed for several seconds in a bath sonicator (Branson 2510) prior to analysis. Viscosity measurements were taken at 25° C. in a water bath, at concentrations from 0.3−0.6 wt % and shear rates from 0.1-100 si.

### Wet Spinning of SCNF.

Aqueous dispersions of 1.3 and 1.8 mmol/g SCNF were concentrated to 0.65 wt % using a rotary evaporator. Aqueous SCNF spin dope was dispensed via a syringe pump fitted with a 27-gauge needle with 210 μm inner diameter (ID) and its tip submerged in a 60 cm long horizontal channel filled with a coagulant of either acetone, IPA, or IPA with 0.1 wt % CaCl₂. The extrusion rate, controlled via syringe pump, was approximately 144 cm/min (3 mL/hr). After moving through the coagulation bath, fibers were pulled through an air gap to dry before being wound onto a cylindrical collector driven by a DC motor at a rate of approximately 170 cm/min.

The diameter, tensile strength, and Young's modulus of wet-spun fibers were determined using a Zellweger-Uster Mantis single fiber tensile tester designed for testing cotton fibers. Fibers were conditioned at 21° C. and 65% relative humidity for at least 24 h prior to tensile tests. SEM images of wet-spun fibers were taken on a Thermo Fisher Quattro S Environmental SEM. Fibers were sputtered with approximately 1.5 nm of gold prior to imaging. Optical microscopy images of fibers were taken under crossed polars with the fiber angled at 45° with respect to the polarization plane.

### Example 1

SCNF were prepared as described above, with varied molar ratios of HSO₃Cl/AGU and varied reaction times, as shown below in Table 1. The SCNF yield and average charge were measured as described above and are reported in Table 1.

TABLE 1

| | | Blending | Reaction | SCNF | Avg. |
|---|---|---|---|---|---|
| | HSO₃Cl:AGU | Time | Time | Yield | Charge |
| | molar ratio | (min.) | (min.) | (%) | (mmol/g) |
| Ex. A | 0.5 | 30 | 60 | 20 | 0.45 |
| Ex. B | 0.75 | 30 | 30 | 90 | 1.05 |
| Ex. C | 1 | 30 | 30 | 97 | 1.30 |
| Ex. D | 1 | 30 | 60 | 96 | 1.35 |
| Ex. E | 1.25 | 30 | 45 | 97 | 1.79 |
| Ex. F | 1.5 | 30 | 30 | 95 | 1.76 |
| Ex. G. | 1.5 | 30 | 60 | 94 | 2.20 |
| Ex. H | 1 | 1 | 30 | 78 | 1.3 |
| Ex. I | 1.25 | 1 | 45 | 80 | 1.8 |

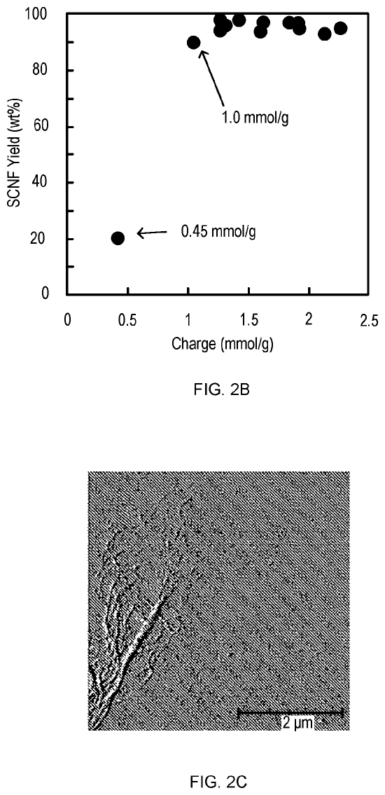

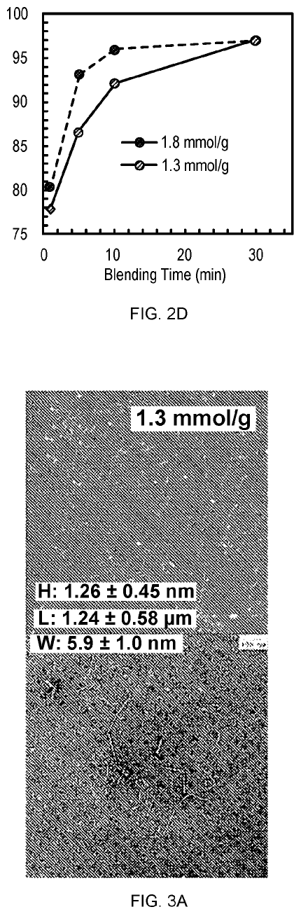

The results are shown in FIGS. 2A-D, which illustrate the effect of sulfation reaction conditions followed by high-speed blending (30 k rpm, 30 min.). FIG. 2A illustrates the surface charge as a function of HSO₃Cl/AGU molar ratios and reaction time. FIG. 2B illustrates the SFNC yield as a function of surface charge (30 min. blending). FIG. 2C illustrates branching fibrils for SCNF with a charge of 1.0 mm/g. FIG. 2D illustrates SCNF yield as a function of blending time.

As shown in Table 1, by varying the HSO₃Cl/AGU molar ratio from 0.5 to 1.5 for reaction times of 30 to 60 mm, sulfated cellulose with charges ranging from 0.45±0.10 to 2.20±0.10 mmol/g were produced. The HSO₃Cl/AGU ratio was found to be the most significant determiner of charge, with a lesser effect observed for reaction time over the conditions studied. The skew in the 30- and 60-minute trendlines indicate a two-factor interaction between time and HSO₃Cl/AGU ratio, wherein longer reaction times magnify the effect of HSO₃Cl/AGU ratio.

High speeding blending of rice straw cellulose without any pretreatment, even for an extended period of 60 minutes, yields less than 5% nanofibrils, as reported by Santos, S., et al. “The Intrinsic Resolution Limit in the Atomic Force Microscope: Implications for Heights of Nano-Scale Features.” PLOS One, 2011, 6 (8). Reaction conditions described herein demonstrate that blending of sulfated cellulose for 30 minutes dramatically increased nanofibril yields as compared to the known methods. The lowest yield of 20% SCNF (Ex. A), corresponded to sulfated cellulose with the lowest charge-0.45 mmol/g, produced with a 0.5 HSO₃Cl/AGU and 60-minute reaction time. This is illustrated in FIG. 2B. The sulfated cellulose produced under all other reaction conditions (Ex. B-F) were able to be defibrillated into SCNF and dispersed in the supernatants at high yields of 90−97% as reported in Table 1. AFM of 1.0 mmol/g SCNF (0.75 HSO₃Cl/AGU, 30 min) showed some highly branched and entangled fibrillar structures (FIG. 2C) which were not observed from other conditions. This observation, along with the 90% yield, may indicate 1.0 mmol/g to be just below the sulfation threshold to permit full disintegration of macroscale sulfated cellulose into nanoscale SCNF.

While a blending time of 30 minutes was chosen for the sake of direct comparison with previously reported TCNF from the same feedstock and defibrillation conditions (Ex. A-F), shorter blending proved to still be effective at liberating large amounts of SCNF, with 1.3 mmol/g SCNF (1 HSO₃Cl/AGU, 30 min) and 1.8 mmol/g showing yields of 78% and 80%, respectively, after only 1 minute of blending (Ex. G-H). These yields are higher than that of rice straw 1.29 mmol/g TCNF at the same blending time (ca. 50%), as reported by Jiang, F. et al., “Controlled Defibrillation of Rice Straw Cellulose and Self-Assembly of Cellulose Nanofibrils into Highly Crystalline Fibrous Materials.” RSS Adv. 2013, 3 (30), 12366−12375. These results showcase the effectiveness of sulfation as a pretreatment for producing nanofibrils.

### Example 2

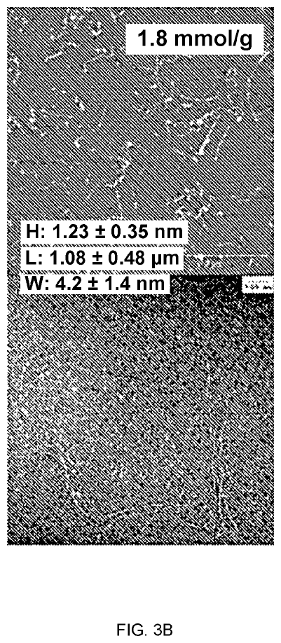

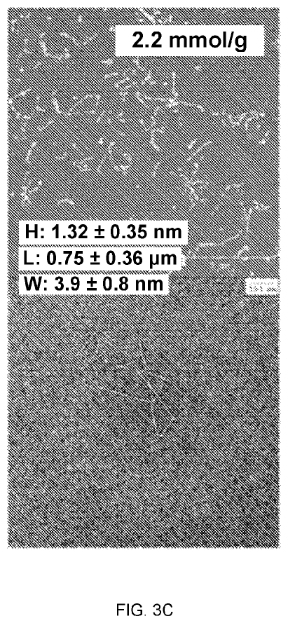

SCNF of Examples C, E, and G were characterized via AFM, TEM, FTIR, and XRD. Of the above Examples, three high-yielding SCNF representing three charge levels of 1.3 mmol/g (1.0 HSO₃Cl/AGU, 30 min) (Ex. C), 1.8 mmol/g (1.25 HSO₃Cl/AGU, 45 min) (Ex. E), and 2.2 mmol/g (1.5 HSO₃Cl/AGU, 60 min)(Ex. G) were selected for further analysis. The average SCNF length (L) decreased from 1.24 μm to 1.08 μm and 0.75 μm with increasing levels of sulfation from 1.3 mmol/g to 1.8 mmol/g and 2.2 mmol/g, as illustrated in FIGS. 3A-C. FIG. 3A illustrates the AFM (top) and TEM (bottom) for Ex. C. FIG. 3B illustrates the AFM (top) and TEM (bottom) for Ex.E. FIG. 3C illustrates the AFM (top) and TEM (bottom) for Ex. G. A progressive reduction in fibril width (W) from 5.9 nm to 4.2 nm and 3.9 nm was also observed with increasing sulfation. The height (H) values of all SCNF ranged from 1.23 to 1.32 nm, with little variation between reaction conditions. The L/H aspect ratios of all three SCNF were high, though they showed a downward trend from 984 to 843 and 568 with increasing sulfation. Based on the H values from AFM and W values from TEM, all three SCNF had rectangular cross sections with W/H ratios of 3.0−4.7. The low H values can in part attributed to the tendency of AFM to underrepresent the heights of nanoscale features, sometimes attributed to sample deformation by the tip, the presence of salts or other deposits on the substrate surface, or when the lateral dimensions being measured are smaller than the effective surface area of the tip, as is the case here. However, these effects are unlikely to account for the significant cross-sectional anisotropy observed. TEMPO CNF produced from the same cellulose feedstock and bearing similar charge (1.29 mmol/g) showed a much more isotropic cross-section (W:2.09 nm, H: 1.52 nm)36, indicating that the anisotropic rectangular cross-section is associated with the chlorosulfonic acid reaction, and not related to cellulose source. Despite the morphological differences, the high 94-97% yields for SCNF were similar to the 96.8% yield of TCNF, also disintegrated by the same blending, affirming that the sulfation of cellulose by chlorosulfonic acid is robust and highly effective at producing SCNF over a wide range of charges.

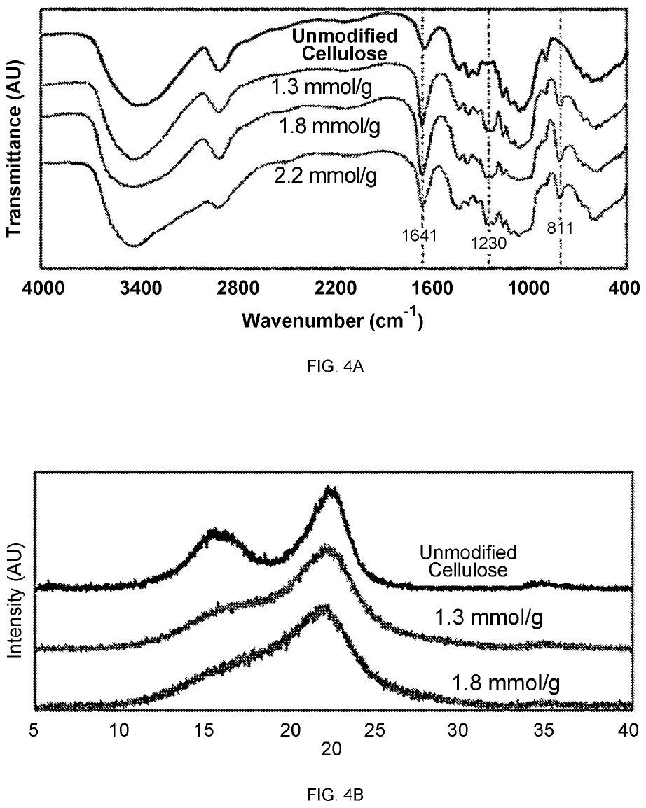

FIG. 4A illustrates the FTIR spectra and FIG. 4B illustrates the XRD profile of Examples C, E, and G as compared to unmodified rice straw cellulose. FTIR transmittance spectra of SCNF samples in FIG. 4A show all major peaks characteristic of cellulose: broad OH stretching around 3500 cm⁻¹, CH2 stretching at 2900 cm⁻¹, and C—O—C stretching of the −1,4 glycosidic linkage at 898 cm⁻¹ (FIG. 3a). In addition, two new peaks characteristic of sulfate half-ester groups appeared at 811 cm⁻¹ and 1230 cm⁻¹ that can be attributed to the S—O and S═O stretching vibrations, respectively. While the intensity of these two sulfate ester peaks showed no clear trend with the levels of sulfation, the water scissoring peak at 1641 cm⁻¹ intensified in all three SCNF. This intensification could be attributed to an increase in hygroscopicity brought about by sulfation and has been observed previously for cellulose sulfates. The most charged 2.2 mmol/g SCNF also showed sharpening of the OH stretching peak and a decrease in the prominence of the CH2 stretching peak compared to the less sulfated SCNF. Both of these traits are more characteristic of amorphous celluloses, indicating possible reduction in crystallinity brought about by the harshest reaction conditions.

XRD profiles of rice straw cellulose as well as 1.3 and 1.8 mmol/g SCNF as shown in FIG. 4B further support the notion that chlorosulfonic acid treatment reduces cellulose crystallinity. The Segal method for calculating cellulose crystallinities gave values of 70%, 50%, and 40% for cellulose, 1.3 mmol/g SCNF, and 1.8 mmol/g SCNF, respectively. Peak deconvolution instead gave values of 76%, 67%, and 60%. Nanomaterials often show broadened peaks in XRD compared to their macroscopic counterparts as a result of the finite size of crystallites; this effect can be clearly seen in the XRD profiles for SCNF by the overlapping of the (200), (110), and (11̅0) peaks. The Segal method does not account for the broadening of crystalline peaks, and as a result is expected to overestimate the amount of amorphous cellulose present. Consistently, both methods of analysis point to a progressive reduction in crystallinity with more sulfated SCNF. As CNF produced by blending the same starting cellulose alone showed slightly higher crystallinity, the reduced crystallinity of SCNF was attributed mainly to the extent of sulfation. Nevertheless, both SCNF retained significant crystallinity.

### Example 3

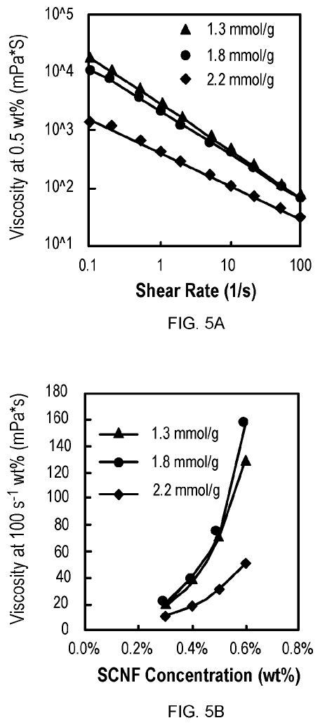

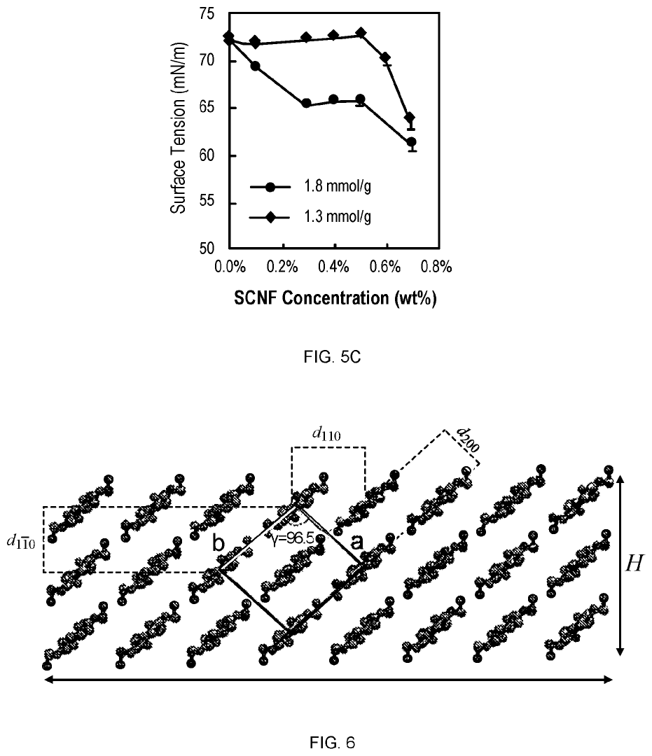

All SCNF dispersions exhibited thixotropy. To account for this, viscosity measurements for Examples C, E, and G were taken after steady state was established for each shear rate. The SCNF dispersions exhibited shear thinning behavior between shear rates of 0.1 and 100s·¹ that fit well to power law kinetics, as shown in FIGS. 5A-B and Table 2, below. Table 2 illustrates the power law viscosity coefficients for Examples C, E, and G, ranging from 0.3 to 0.6 wt %.

TABLE 2

| | SCNF Charge | Concentration | | |
|---|---|---|---|---|
| | (mmol/g) | (wt %) | K (mPa · s) | n |
| Ex. C | 1.3 | 0.3 | 152 | 0.5484 |
| | | 0.4 | 1122 | 0.2488 |
| | | 0.5 | 3029 | 0.1811 |
| | | 0.6 | 8162 | 0.1264 |
| Ex. E | 1.8 | 0.3 | 133 | 0.5797 |
| | | 0.4 | 719 | 0.3311 |
| | | 0.5 | 2295 | 0.2241 |
| | | 0.6 | 9384 | 0.1274 |
| Ex. G | 2.2 | 0.3 | 18 | 0.8897 |
| | | 0.4 | 81 | 0.6793 |
| | | 0.5 | 410 | 0.4288 |
| | | 0.6 | 2563 | 0.1358 |

The viscosity, measured in mPa·s, of the most highly charged 2.2 mmol/g SCNF was approximately an order of magnitude below the 1.3 and 1.8 mmol/g SCNF at most shear rates tested. The significantly lower viscosity of the 2.2 mmol/g SCNF may be attributed to both reduced nanofibril lengths as well as higher charge, leading to increased electrostatic repulsion between fibrils and decreased propensity for entanglement. The thixotropic and shear thinning behaviors of SCNF are similar to those observed for TCNF (reported by Jiang et al., “Controlled Defibrillation of Rice Straw Cellulose and Self-Assembly of Cellulose Nanofibrils into Highly Crystalline Fibrous Materials” RSC Adv. 2013, 3(30), 12366−12375 and Lasseuguette et al., “Rheological Properties of Microfibrillar Suspension of TEMPO-Oxidized Pulp” Cellulose 2008, 15(3), 425−433). At 0.5 wt %, the viscosities of the aqueous 1.3 mmol/g SCNF dispersions are similar to those reported for SCNF (reported by Sirvio et al., “Direct Sulfation of Celluose Fibers Using a Reactive Deep Eutectic Solvent to Produce Highly Charged Cellulose Nanofibers” Cellulose 2008, 15(3), 489−496) produced from softwood pulp using sulfamic acid and urea, indicating similarity in nanofibrillar characteristics between the two sulfation schemes. The effective viscosities as a function of shear rate are illustrated in FIG. 5A and the viscosities as a function of concentration are illustrated in FIG. 5B.

### Example 4

Examples C, E, and G were further tested for their amphiphilicity. Each Examples showed amphiphilicity, reducing the surface tension of water with increasing concentrations, as shown in FIG. 5C. This reduction was more pronounced for higher anisotropic cross-section (W/H:4.7) and lower 1.3 mmol/g charged SCNF (Ex. C) as compared to the less anisotropic (W/H:3.4) and higher charged 1.8 mmol/g SCNF (Ex. E), which only showed a reduction at higher concentrations of 0.6−0.7%. This surface active behavior of the 1.8 mmol/g SCNF is, once again, similar to TCNF, which exhibited a similar reduction in surface tension with 1.29 mmol/g charge at ca. 0.3% (reported by Xu, X., et al. “Aqueous Exfoliated Graphene in Amphiphilic Nanocellulose and Its Application in Moisture-Responsive Foldable Actuators” Nanoscale 2019, 11(24), 11719−11729). However, amphiphilicity of these SCNF has not been reported on any other sulfated or sulfonated nanocelluloses.

### Example 5

The SFCN cross section and surface functionalization were studied next. Due to the semicrystalline structure of cellulose, only the chains in the amorphous regions or on exposed crystallite surfaces were susceptible to functionalization. Representing the degree of substitution (DS) on a basis of total anhydroglucose units in cellulose, therefore, does not reflect the surface characteristics of SCNF. To represent the functionalization of cellulose in terms of accessible surface hydroxyls, a model was developed based on cross-sectional dimensions determined by AFM and TEM. The model assumes that SCNF possess crystalline cores of the cellulose 1 structure with exposed hydrophilic (110) and (11̅0) planes bearing hydroxyl groups that are susceptible to chemical

Modification. A cross-sectional model of SCNC with cellulose 1β unit cell and d-spacings is illustrated in FIG. 6. The lattice parameters used for cellulose 1 are a==90°, y=96.5° a=7.78 A, b=8.20 A, c=10.38 A.

In this cross-sectional lattice, the number of chains in the width and height directions can be represented by H/d₁1̅0+1 and W/d₁₁₀+1, where H and W are the fibril height and width as determined from AFM and TEM, respectively. The total number of cellulose chains in the cross section, N, may be given by:

$$N = ( \frac{H}{{d}_{1 \overline{1} 0}} + 1 ) + ( \frac{W}{{d}_{110}} + 1 ) .$$

The number of cellulose chains on the fibril surface along the (110) and (11̅0) planes, Ns, is expressed as:

$${N}_{s} = 2 * [ ( \frac{H}{{d}_{1 \overline{1} 0}} + 1 ) + ( \frac{W}{{d}_{110}} + 1 ) ] - 2 = 2 ( \frac{W + H}{5.65 Å} + 1 ) ,$$

where the −2 is necessary to avoid double counting the corner chains and d₁₁₀=d₁1̅0=5.65 Å. The number of surface hydroxyls or OHs per AGU (<p) can be expressed by dividing the number of surface cellulose chains Ns by the total number of cellulose chains N and multiplying by the number of surface hydroxyls per exposed surface AGU, 1.5 (3 surface hydroxyls-C2, C3, and C6—for every cellobiose or 2 AGU exposed on the 110 or 11̅0 planes).

Finally, the percentage of exposed hydroxyls that are sulfated is expressed by dividing the charge (mmol/g) by the total AGU (mmol/g) multiplied <p as follows:

$$\% Exposed OH Sulfated = \frac{S C N F Charge}{Total A G U * φ}$$

This fraction is shown alongside the overall degree of substitution for Examples C, E, and G in Table 3 below. The degree of substitution reports the number of sulfate groups per total AGU.

TABLE 3

| | SCNF Charge | Degree of | % Exposed OH | % Exposed C6 |
|---|---|---|---|---|
| | (mmol/g) | Substitution | Sulfated | Sulfated |
| Ex. C | 1.3 | 0.24 | 19 | 57 |
| Ex. E | 1.8 | 0.34 | 24 | 72 |
| Ex. G | 2.2 | 0.43 | 31 | 93 |

Previous work using NMR on dissolved cellulose sulfate produced by the same reaction but under harsher conditions (2 HSO₃Cl/AGU for 5 h) found no measurable secondary C2/C3 hydroxyl substitution (reported by Moreno-Herrero et al. “DNA Height in Scanning Force Microscopy” Ultramicroscopy 2003, 96(2), 167−174). Since the reaction conditions used were milder those known, it may be reasonable to assume that C6 sulfation was dominant. That being the case, complete sulfation of exposed surface C6 hydroxyls may be expected at 33% surface sulfation; the 2.2 mmol/g SCNF approaches this value at 31%, with an estimated 93% of accessible C6 hydroxyls sulfated. The simplicity and selectivity of chlorosulfonic acid treatment of cellulose under relatively mild conditions may be particularly compelling in the context of competing with carboxylated TEMPO CNF, which may be lauded for its specificity for C6 carboxylation.

### Example 6

The aqueous SCNF of Examples C and E were wet-spun at a 0.65 wt % concentration through a 27 gauge needle (210 μm ID). The extrusion and take-up rates were 144 cm/s and 170 cm/s, respectively, giving effective viscosities during extrusion on the order of 100 mPa·s. The prospect of higher spinning rate is promising by increasing the size of the coagulation batch to maintain adequate residence time as part of scaling up the wet spinning operation in the future. Several different coagulants were used, including acetone and IPA as organic coagulants and a mixed ionic/organic coagulant consisting of 0.1 wt % CaCl₂) in IPA The removal of water from fibers coagulated in aqueous CaCh necessitates a long and continuous coagulation path and long drying times that are difficult to implement on the laboratory scale. Using solutions of CaCl₂) in IPA alleviates this problem, with the increased volatility of isopropanol facilitating faster drying.

The spinnability of aqueous SCNF was found to vary with respect to their charges. The 1.3 mmol/g SCNF (Ex. C) was able to be continuously spun into fibers in all coagulants tested. Under the same spinning conditions, the higher charged 1.8 mmol/g SCNF (Ex. E) did not coagulate uniformly in either IPA or acetone, becoming fragmented or too delicate to be handled or collected. The poorer coagulation behavior of the 1.8 mmol/g SCNF in organic solvents may be attributed to several factors. The higher charge of the SCNF leads to increased inter-fibrillar electrostatic double-layer repulsion, hampering their association during coagulation. The higher quantities of hygroscopic sulfate groups in the 1.8 mmol/g SCNF also retain more bound water molecules, further hindering interfibrillar association and slowing coagulation. Conversely, the 1.8 mmol/g SCNF could be easily spun into IPA with 0.1 wt % CaCl₂). With divalent calcium ions screening electrostatic repulsion and higher charge facilitating ionic cross-linking, this system is well suited for spinning fibers from this more highly substituted SCNF.

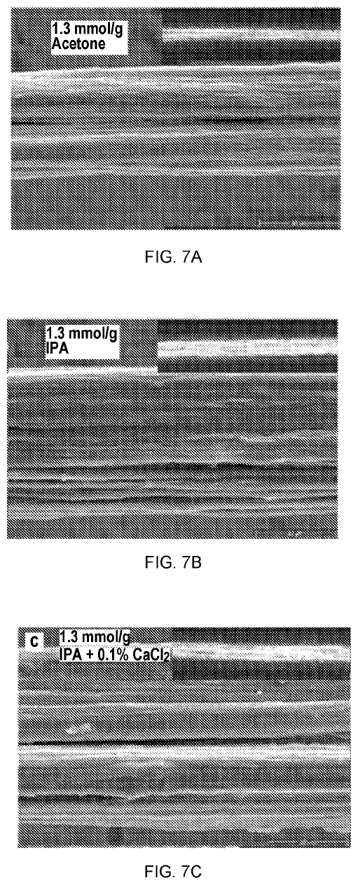

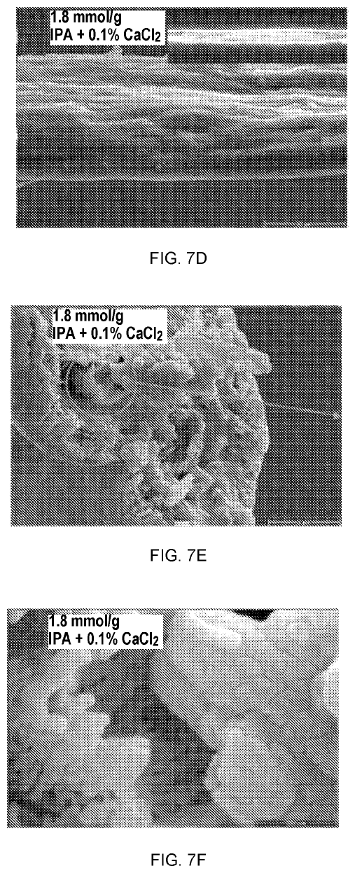

Microscopy on wet-spun fibers showed clear evidence of nanofibrillar alignment, necessary for achieving strong fibers. Surface striations along the fibrillar axis were observed in SEM images, as illustrated in FIGS. 7A-D. FIG. 7A illustrates a longitudinal SEM image of wet-spun SNCF fibers according to Example C in acetone. FIG. 7B illustrates a longitudinal SEM image of wet-spun SNCF fibers according to Example C in IPA. FIG. 7C illustrates a longitudinal SEM image of wet-spun SNCF fibers according to Example C in acetone with 0.1 wt % CaCl₂). FIG. 7D illustrates a longitudinal SEM image of wet-spun SNCF fibers according to Example E in IPA with 0.1 wt % CaCl₂). FIG. 7E illustrates a longitudinal SEM image of wet-spun SNCF fibers with a fractured surface according to Example E in IPA with 0.1 wt % CaCl₂). FIG. 7F illustrates an enlarged longitudinal SEM image of wet-spun SNCF fibers with a fractured surface according to Example E in IPA with 0.1 wt % CaCl₂). Optical microscopy of fibers viewed under crossed polars showed bright birefringence in all cases (FIGS. 7A-D, insets), further confirming the bulk alignment of SCNF. SEM of a tensile fractured end from a fiber coagulated in CaCh/IPA showed lamellar structures aligned along the fibrillar axis (FIGS. 7E-F). While these oriented fibrillar structures showed clear SCNF alignment or assembly at the nanofibril level, inter-fibrillar spacings were also visible. Combined with the larger diameter of the fiber coagulated in CaCl₂)/IPA, ionic coagulation of the more highly charged 1.8 mmol/g SCNF produced fibers with a greater degree of porosity than those 1.3 mmol/g charged SCNF coagulated in pristine organic solvents. The fibers coagulated in IPA and IPA+CaCl₂) also showed increased porosity as compared to those coagulated in acetone, as evidenced by the larger fiber diameter for equal spinning/take-up rates.

The tensile properties of the wet-spun SCNF fibers showed a strong dependence on the type of coagulant. The highest Young's modulus of 26.0±4.8 GPa and tensile strength of 675±120 MPa as well as the lowest breaking strain of 6.6±1.2% were achieved for 1.3 mmol/g SCNF coagulated in acetone, followed by those coagulated in IPA and IPA/CaCl₂) with respective mean tensile modulus of 16.1 and 8.5 GPa and tensile strength of 422 and 188 MPa. The results are reported in Table 4 below.

TABLE 4

| | Ex. C | | | Ex. E |
|---|---|---|---|---|
| SCNF Charge | 1.3 | | | 1.8 |
| (mmol/g) | | | | |
| Coagulant | Acetone | IPA | IPA + 0.1 wt % CaCl₂ | |
| Fiber | 10.1 ± 1.2 | 15.2 ± 3.0 | 16.3 ± 2.4 | 16.4 ± 3.6 |
| Diameter (μm) | | | | |
| Strain at Break (%) | 6.6 ± 1.2 | 8.4 ± 1.1 | 12.6 ± 1.6 | 7.0 ± 2.5 |
| Tensile | 675 ± 120 | 422 ± 160 | 188 ± 53 | 219 ± 60 |
| Strength (MPa) | | | | |
| Young's | 26.0 ± 4.8 | 16 ± 6.1 | 8.5 ± 2.5 | 9.3 ± 2.3 |
| Modulus (GPa) | | | | |

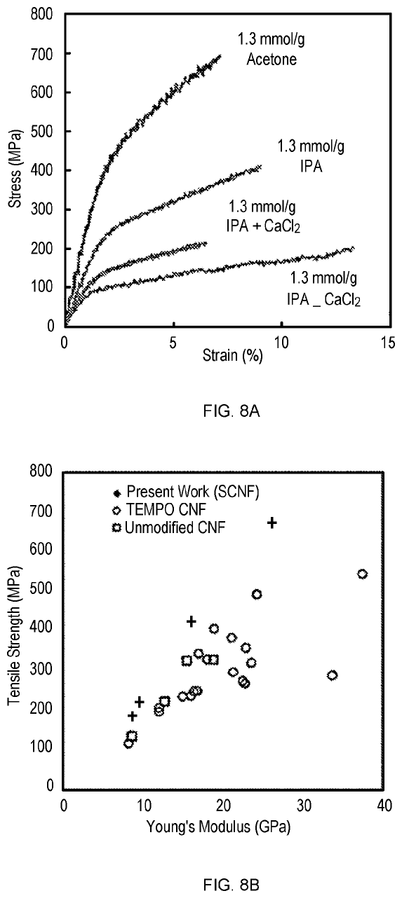

The mechanical performance of wet-spun SCNF fibers was found to positively correlate with the relative speeds at which each solvent system is expected to coagulate, as illustrated in FIG. 8A, which illustrates tensile strength of wet-spun SCNF fibers on a representative stress strain curve. Coagulation in acetone was visibly faster than in IPA, possibly due to the weaker interactions between acetone and SCNF; acetone cannot act as a hydrogen bond donor while IPA can. The IPA/CaCl₂) system coagulated even more slowly, as the ionic cross-linking and coagulating of the fiber's surface forming a skin that hampers ion diffusion to and from the core and water diffusion out of the fiber. This may also contribute to the increased porosity observed in fibers coagulated from the IPA/CaCl₂) system. The fibers spun from 1.8 mmol/g SCNF were equal in diameter and similar in tensile strength and modulus (ca. 219 MPa and 9 GPa, respectively) to those from 1.3 mmol/g SCNF, both spun into PA/CaCl₂, but significantly lower strain at break.

When compared to fibers wet-spun from a variety of CNF-both TEMPO and unmodified in the literature (as reported in Iwamoto et al., “Structural and Mechanical Properties of Wet-Spun Fibers Made from Natural Cellulose Nanofibers.” Biomacromolecules 2011, 12(3), 831−836; Lundahl et al., “Strength and Water Interactions of Cellulose I Filaments Wet-Spun from Cellulose Nanofibril Hydrogels” Sci. Rep. 2016, 6 (Jul.), 1−13; Rosen T., et al. “Elucidating the Opportunities and Challenges for Nanocellulose Spinning” Adv. Mater., 2021, 33. 200128; and Abitbol, T., et al. “Nanocellulose, a Tiny Fiber with Huge Applications.” Curr. Opin. Biotechnol. 2016, 39, 76−88) as shown in FIG. 8B, all four fibers from SCNF showed higher tensile strength at corresponding modulus, with the acetone coagulated fiber from 1.3 mmol/g SCNF having the highest tensile strength (675±120 MPa) and modulus (26.0±±4.8 GPa). The CNF and tensile properties of wet-spun fibers from the literature and from Examples C and E are reported below in Table 5.

TABLE 5

| | | | | Tensile | Young's | Strain |
|---|---|---|---|---|---|---|
| | Cellulose | Charge | | Strength | Modulus | at |
| CNF Type | Source | (mmol/g) | Coagulant | (MPa) | (GPa) | Break (%) |
| TEMPO | Wood | 0.54 | THF | 118 | 8.2 | 8.3 |
| | | 0.54 | THF | 289 | 33.7 | 1.6 |
| | | 0.6 | Acetone | 236 | 15 | 4.6 |
| | | 0.6 | CaCl₂ (10 wt %) | 344 | 17 | 4.5 |
| | | 0.6 | Ethanol | 207 | 12 | 3.6 |
| | | 0.6 | HCI (pH = 2) | 329 | 18 | 2.7 |
| | | 1.36 | Acetone | 297 | 21.3 | 2.8 |
| | | 1.36 | Acetone | 237 | 16 | 2.8 |
| | | — | CaCl₂ (5 wt %) | 543 | 37.5 | 3.7 |
| | | — | CaCl₂ (5 wt %) | 492 | 24.3 | 11.8 |
| | | — | CaCl₂ (5 wt %) | 383 | 21.1 | 6.6 |
| | | — | CaCl₂ (5 wt %) | 250 | 16.8 | 9.2 |
| | | — | Ethanol, Dioxane, or THF | 275 | 22.5 | 4 |
| | | — | Acetone | 321 | 23.6 | 2.2 |
| | Tunicate | — | Acetone | 406 | 18.9 | 5.6 |
| | Jute | 1.5 | Acetone | 269 | 22.8 | 2 |
| | Bacterial | 0.65 | Acetone | 358 | 22.9 | 2.3 |
| | Cellulose | 0.65 | Acetone | 249 | 16.4 | 3.8 |
| | | 0.65 | Acetone | 198 | 12 | 4.5 |
| Unmodified | Wood | N/A | Acetone | 136 | 8.6 | 3.7 |
| | | N/A | Acetone | 326 | 15.5 | 6.9 |
| | | N/A | Acetone | 223 | 12.7 | 8.4 |
| | | N/A | Ethanol | 328 | 18.8 | 12.1 |
| SCNF | Rice Straw | 1.3 | Acetone | 675 | 26.0 | 6.6 |
| | | 1.3 | Isopropanol | 422 | 16.1 | 8.4 |
| | | 1.3 | IPA + 0.1 wt % CaCl₂ | 188 | 8.5 | 12.6 |
| | | 1.8 | IPA + 0.1 wt % CaCl₂ | 219 | 9.3 | 7.0 |

*“—”denotes not provided for TCNF. NIA denotes not applicable for unmodified CNF-values for non-SCNF cellulose sources are reported in Torres-Rendon, J. et al., “Mechanical Performance of Macrofibers of Cellulose and Chitin Nanofibrils Aligned by Wet-Stretching: A Critical Comparison.” Biomacromolecules 2014, 15(7), 2709.2717; Wang., L et al.; “Effects of Non-Solvents and Electrolytes on the Formation and Properties of Cellulose I Filaments” Sci. Rep. 2019, 9(1), 1-11; Lundahl, M. J., et al. {Strength and Water Interactions of Cellulose I Filaments Wet-Spun from Cellulose Nanofibril Hydrogels,” Sci. Rep. 2016, 6(July), 1-13; Vuoriluoto, M. et al., “Filaments with Affinity Binding and Wet Strength Can Be Achieved by Spinning Bifunctional Cellulose Nanofibrils.” Biomicromolecules 2017, 18(6), 1803-1813; Kim, H.C. et al.; “Effect of Wet Spinning and Stretching to Enhance Mechanical Properties Nanofiber Filament” Int. J. Precis. Eng. Manuf.-Green Technol., 2019, 6(3), 567-575; Kafy, A., et al. “ Cellulose Long Fibers Fabricated from Cellulose Nanofibers and Its Strong and Tough Characteristics.” Sci. Rep. 2017, 7(1), 1-8; Walther, A., et al.; “Multifunctional High-Performance Biofibers Based on Wet-Extrusion of Renewable Native Cellulose Nanofibrils.” Adv. Mater, 2011, 22 (26), 2924-2928; Iwamoto et al., “Structural and Mechanical Properties of Wet-Spun Fibers Made from Natural Cellulose Nanofibers.” Biomacromolecules 2011, 12(3), 831-836; Geng L., et al. “Strength and Modulus Improvement of Wet-Spun Cellulose I Filaments by Sequential Physical and Chemical Cross-Linking.” Mater. Des. 2017, 136, 45-53; Yao, J. et al., “Macrofibers with High Mechanical Performance Based on Aligned Bacterial Cellulose Nanofibers.” ACS Appl. Mater. Interfaces 2017, 9 (24), 20330-20339; Lunhahl, M. J., et al.; “Strength and Water Interactions of Cellulose I Filaments Wet-Spun from Cellulose Nanofibril Hydrogels.” Sci. Rep. 2016, 6 (July), 1-13; and Mohammadi, P. et al., “Aligning Cellulose Nanofibril Dispersions for Tougher Fibers.”

Only two previously reported fibers had higher modulus but their tensile strengths were lower than the highest here (as reported in Torres-Rendon, J. et al., “Mechanical Performance of Macrofibers of Cellulose and Chitin Nanofibrils Aligned by Wet-Stretching: A Critical Comparison.” Biomacromolecules 2014, 15(7), 2709, 2717 and Kim, H. C. et al.; “Effect of Wet Spinning and Stretching to Enhance Mechanical Properties Nanofiber Filament” Int. J. Precis. Eng. Manuf-Green Technol., 2019, 6(3), 567−575). Those reported fibers compared were mostly spun under similar conditions as the SCNF fibers reported here and coagulated predominantly in acetone or aqueous CaCl₂) with no polymeric additives. The TCNF charges reported were mostly between 0.54 and 0.65 mmol/g, with only three possessing higher charges of 1.36 and 1.5 mmol/g; generally lower than the 1.3−1.8 mmol/g SCNF fibers (as reported in Lunhahl, M. J., et al.; “Strength and Water Interactions of Cellulose I Filaments Wet-Spun from Cellulose Nanofibril Hydrogels.” Sci. Rep. 2016, 6 (Jul.), 1−13; Vuoriluoto, M. et al., “Filaments with Affinity Binding and Wet Strength Can Be Achieved by Spinning Bifunctional Cellulose Nanofibrils.” Biomicromolecules 2017, 18(6), 1803−1813; and Geng L., et al. “Strength and Modulus Improvement of Wet-Spun Cellulose I Filaments by Sequential Physical and Chemical Cross-Linking.” Mater. Des. 2017, 136, 45−53). The fibers wet-spun from SCNF in acetone were among the strongest fibers wet-spun from CNF-either unmodified or TEMPO oxidized-without using flow focusing. In fact, all four fibers from SCNF were wet-spun without any additional drawing nor post-spinning treatment to enhance orientation-highlighting the intrinsic attributes of SCNF as a structural material.

Given that one significant draw of nanocelluloses is their renewability, it is important to consider the sustainability and environmental impact of the chlorosulfonic acid/DMF system for producing SCNF compared to alternative routes. While anhydrous DMF makes the sulfation of cellulose robust and efficient, the impact of DMF may be minimized by reuse and recycling. The heterogeneous nature of this process makes collection of the macroscale cellulose sulfate product easy by simple solid-liquid separation processes of sedimentation and filtration. Due to the low concentration of chlorosulfonic acid in the reaction mixture (−1 v/v %), additional acid could be readily added to the separated solvent, for direct reuse. Built up reaction byproducts (i.e., HCl) could be removed along with other impurities through a small purge stream.

This disclosure reports for the first time the facile sulfation-disintegration approach of producing sulfated CNF (SCNF) by direct sulfation of macroscale cellulose with chlorosulfonic acid (HSO₃Cl) to achieve a tunable range of sulfation while avoiding dissolution. Robust sulfation at moderate 1 to 1.5 HSO₃Cl/AGU molar ratios at ambient temperature for 30 to 60 min produced sulfated cellulose that could be disintegrated by high-speed blending (30 k rpm, 30 min) to yield 94 to 97% SCNF with 1.3 to 2.2 mmol/g charges. With increasing extent of sulfation, the resulting SCNF had similar heights (H) of 1.23−1.32 nm, but lowered widths (W) from 5.9 to 3.9 nm and lengths (L) from 1.24 to 0.75 μm. All SCNF had anisotropic cross-sections (W/H: 3.0−4.7) and very high aspect ratios (L/H: 568−984) as well as exhibited amphiphilic, thixotropic, and shear thinning behaviors between 0.1 and 100 s′ shear rates. Aqueous SCNF with 1.3 and 1.8 mmol/g charges could be wet-spun into 10−16 μm wide fibers continuously without drawing.

This disclosure quantifies the effectiveness of chlorosulfonic acid treatment for simultaneously pretreating and functionalizing cellulose to produce sulfated CNF (SCNF). This disclosure also demonstrates the potential of SCNF as a structural material by wet spinning SCNF into high-strength fibers. For example, cellulose was heterogeneously sulfated with chlorosulfonic acid in anhydrous N,N-dimethylformamide, with reaction conditions being optimized to provide sufficient sulfation while minimize dissolution to afford disintegration into aqueous-dispersible SCNF through high-speed blending. The degree of sulfation was investigated by varying the stoichiometric ratio of chlorosulfonic acid per anhydroglucose unit (AGU) and the reaction time at ambient temperature. Structure-property relationships were explored between SCNF charge, dimensions, morphology, and rheology. Aqueous SCNF dispersions were wet spun into varied coagulants of acetone, isopropanol, and mixtures of calcium chloride and isopropanol to explore the assembly of SCNF into fibers and relate SCNF charge and spinning conditions to fiber morphology and strength.

### Materials for Examples 7

Anhydrous N,N-dimethylformamide, Sodium persulfate, Iron(III) sulfate monohydrate, and Poly(styrene sulfonic acid) (75 kDa, aqueous, 18 wt %) were purchased from Sigma-Aldrich. 3,4-ethylenedioxythiophene was purchased from Acros. Chlorosulfonic acid was purchased from Alfa Aesar. Sheets of softwood dissolving pulp cellulose were received from the US Forest Product Laboratory of the US Forest Service in Madison, WI. Ultra-pure water was acquired from a Milli-Q Advantage A10 water purification system. Regenerated cellulose dialysis tubing was purchased from Spectrum Laboratories. Unless otherwise specified, all chemicals were utilized as-is.

Synthesis and characterization of sulfated cellulose nanofibrils. SCNF was produced from dissolving pulp cellulose through a previously reported procedure.²³ Cellulose pulp sheets (1.0 g) were torn into squares with sides of 1 cm or smaller and placed in a 50 mL round-bottom flask. Anhydrous DMF (45 mL) was added to the flask and the cellulose pulp was allowed to disperse under vigorous stirring for 2 hours. Chlorosulfonic acid (1.25 moles per mole of anhydroglucose) was added dropwise to 5 mL of anhydrous DMF chilled in an ice bath to prevent excessive heating. This acid/DMF mixture was added to the dispersed pulp and the reaction was allowed to proceed for 45 minutes. Termination was carried out through the addition of 10 mL of purified water, after which the cellulose sulfate product was washed with more water by repeated centrifugation and decanting. Residual DMF and acid was removed through dialysis against purified water changed daily for a period of approximately one week, until the conductivity of the dialyzing water plateaued below 1 μS/cm. Sulfated cellulose was disintegrated by 10 minutes of high-speed blending (Vitamix 5200, 30,000 RPM) at a concentration of 0.2 wt %. Blending was performed in 5-minute increments with cooldown periods between to avoid excessive heating. SCNF was concentrated as needed using a rotary evaporator.

The height and length of SCNF were assessed using atomic force microscopy (AFM) (Asylum Research MFP-3D) using OMCL-AC160TS standard silicon probes with a nominal tip radius of 7 nm and spring constant of 26 N/m. Several drops of SCNF diluted to 0.00003 wt % were deposited on freshly cleaved mica disks and dried under ambient conditions. AFM surface profiles were collected in AC mode and processed using the open-source programs Gwyddion and ImageJ to determine fibril dimensions. The width of SCNF was additionally assessed using transmission electron microscopy (TEM). Aqueous SCNF was diluted to 0.01 wt % and deposited on a glow discharged TEM grid (carbon/formvar over 300 mesh copper). After 10 minutes the excess was blotted off and the samples was repeatedly stained with 2 wt % uranyl acetate. Micrographs were taken at 50,000× magnification on a JEOL JEM 2100F-AC TEM. Micrographs were analyzed with the program imageJ, with SCNF widths being determined by finding the full width at half maximum (FWHM) of the intensity profiles across fibrils.

SCNF charge was determined through conductometric titration. SCNF was dialyzed again against purified water for several days to remove small-molecule contaminants, after which it was run through an ion exchange column loaded with a strong acid exchange resin (DOWEX Marathon C) to ensure that the sulfate half-ester groups were in their acid form. Titration was carried out with 0.01 M NaOH and the equivalence point was determined by finding the minima in the conductivity curve where all acidic sulfate groups were neutralized.

The crystallinity of the dissolving pulp cellulose and all nanocellulose samples was determined through X-ray diffraction (XRD). Films of SCNF were made by depositing 10 mL of SCNF at a concentration of 0.2 wt % in a glass dish and allowing it to dry at 50° C. The dissolving pulp was ground to mash and the powder packed on. Scans were collected on a Bruker D8 Advance Eco diffractometer with a Cu Ku radiation source. Films were scanned at 20 values ranging from 5° to 400 with an angular increment of 0.03° and a scan time of 2.5 s per increment. Crystallinity was estimated using a peak deconvolution with four crystalline peaks and the fitting software Fityk.²⁴ The XRD peaks were modeled as Voigt functions.

Formation of PEDOT:PSS:SCNF Complexes. All PEDOT complexes utilized in here were synthesized through the chemical polymerization of EDOT in the presence of either SCNF, PSS, or some mixture thereof. The amount of EDOT in the reaction mixture was varied between 29 and 50 wt %, corresponding to final polyanion:PEDOT weight ratios of between 2.5:1 and 1:1. For each reaction, 0.1-0.25 g of the polyanion or polyanion mixture were added to a 50 mL round bottom flask and purified water was added to reach a total volume of 50 mL. EDOT (0.1 g) was added and allowed to dissolve for two hours under magnetic stirring. The mixture was degassed via 10 minutes of sonication (Branson 2510 bath sonicator) and the reaction was started by adding sodium persulfate (0.234 g) oxidant and a small amount of ferric sulfate catalyst (10.5 mg). Reactions were allowed to proceed for a period of 24 hours, at which point the PEDOT complexes were brought up to neutral pH through the addition of NaOH and then purified via dialysis against ultrapure water using regenerated cellulose dialysis tubing with a molecular weight cutoff of 3 kDa. Once the conductivity of the dialyzing water plateaued, the complexes were concentrated using a rotary evaporator to 0.8 wt %.

Characterization of PEDOT complexes. PEDOT:SCNF and PEDOT:PSS:SCNF were imaged by AFM with a procedure similar to the one detailed for SCNF. PEDOT complexes were diluted to 0.00008 wt %, deposited on mica, and scanned using an Asylum Research MFP-3D atomic force microscope. TEM micrographs were collected and analyzed for PEDOT:PSS and PEDOT:PSS:SCNF dispersions utilizing a procedure analogous to that outlined previously for the analysis of SCNF.

Films of PEDOT complexes were cast on glass substrates. Glass squares 2.5 cm on each side were first cleaned through sonication in acetone, followed by a rinse in isopropanol. Substrates were then soaked in 30% nitric acid for a period of at least 24 hours to increase surface hydrophilicity. Films of PEDOT dispersions were deposited through drop casting 250 L of dispersion at a concentration of 0.8 wt %. Each dispersion was cast both as-is and with the addition of 5 wt % of ethylene glycol (EG) or dimethyl sulfoxide (DMSO) to act as conductivity enhancers. Films were allowed to dry in air and then cured at 120° C. for 60 minutes.

The resistivity of films was measured using the four-point probe method with colinear probes. Multiple resistivity measurements were taken for each film and averaged. Thickness was measured by using AFM in place of a stylus profilometer, measuring the height difference between the bulk of the film and the substrate surface in several locations after scoring a groove in the film. Multiple height measurements were taken for each film and averaged. Conductivity was calculated from thickness and resistivity measurements.

The thermal decomposition of PEDOT:PSS/SCNF complexes was assessed using thermogravimetric analysis (TGA). Dispersions at 0.8 wt % were oven dried overnight at 50° C. Between 3 and 5 mg of these dispersions were placed in a platinum pan and analyzed using a Shimadzu TGA-50 in a nitrogen environment with a heating rate of 10° C./min and a maximum temperature of 500° C.

### Example 7

SCNF Properties. One factor that can confound the literature involving CNF, including the works utilizing CNF in conjunction with PEDOT, is that most groups synthesize their nanofibrils in-house with different starting materials, reagents, and synthesis procedures, leading to variability in nanofibril dimensions, crystallinity, and functionalization. It is therefore imperative that work involving CNF includes adequate dimensional and chemical characterization. The average dimensions of SCNF measured by AFM and TEM were 880±320 nm long, 3.6±0.9 nm wide, and 1.7±0.7 nm high, respectively, as reported in FIG. 10. The AFM results are shown in the top left portion of FIG. 10 and the TEM results are shown in the top right portion of FIG. 10. A summary of the SCNF properties as measured is provided in the bottom portion of FIG. 10. The surfaces were decorated with 1.81±0.09 mmol of sulfate half-ester groups (R—OSO₃⁻) per gram of SCNF. The nanofibrils had a crystallinity index of 58%, down from 78% from the starting material due to the effects of chlorosulfonic acid treatment.

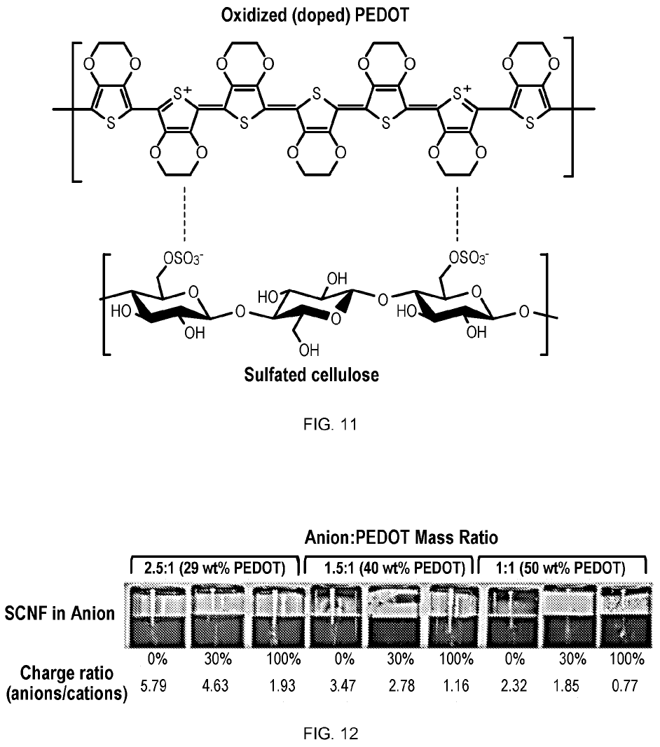

Applying a previously documented²³ model for determining the degree to with nanofibril surfaces are functionalized by looking at fibril cross sectional dimensions estimates that ˜₂₈% of exposed surface hydroxyl groups are sulfated. As sulfation via chlorosulfonic acid is known to occur preferentially at the C6 position,²⁵ it can be estimated that 84% of exposed C6 hydroxyls are sulfated. Adjacent C6 hydroxyls on a nanofibril's outward facing surface are located every other anhydroglucose unit 10.38 Å apart, as shown in FIG. 11. Factoring in unfunctionalized sites by dividing this spacing by the estimated percentage of C6 surface sulfation, an average charge spacing for the SCNF used can be estimated as 12.3 Å. This charge spacing has ramifications for how SCNF forms polyelectrolyte complexes with PEDOT. Two molecular arrangements for polyelectrolyte complexes are typically discussed: the ladder type, where polycation and polyanion chains are paired more parallel to each other and “scrambled egg” type based on more random pairing between multiple polycation and polyanion chains.² While most polyelectrolyte complexes exist somewhere between these two extremes, similar charge spacing between the polycation and polyanion and a large discrepancy between the molecular weights of the two polymers have shown to favor the more organized ladder-like structure.²⁶ Doped PEDOT was found to carry approximately one positive per three thiophene rings² and had a repeating unit length of 3.963 Å,²⁷ leading to an expected charge spacing of 11.89 Å; reasonably similar to the spacings of SCNF. SCNF and PEDOT possess a vast difference in molecular weights, as SCNF are hundreds of nanometers long while PEDOT typically has very low molecular weights, on the order of several kDa.² Both of these factors favor the formation of more ordered ladder-like complexes.

### Example 8: Properties of PEDOT:PSS/SCNF Dispersions and Complexes

PEDOT:PSS/SCNF complexes were synthesized with varying amounts of PEDOT and anions to assess dispersion stability. Complexes containing 29 wt % PEDOT (a 2.5:1 mass ratio of polyanion to PEDOT), 40 wt % PEDOT (1.5:1 polyanion:PEDOT), and 50 wt % PEDOT (1:1 polyanion:PEDOT) were made. For each of these PEDOT fractions, three batches were made with three varying SCNF polyanion compositions of 0, 30, and 100 wt % SCNF, with any remainder being PSS. These dispersions were left in glass vials for 21 days at a concentration of 0.2 wt % and then inverted to check for settling, as shown in FIG. 12. The PEDOT:PSS containing no SCNF showed very little sedimentation at a PSS:PEDOT ratio of 2.5:1; this is to be expected, as this is the most commonly reported and utilized. As the PSS:PEDOT ratio lowered to 1.5 and 1, or PEDOT content increased to 50 and 50%, significant amounts of sediment was observed, more so than any other conditions tested, despite the fact that both of these conditions maintain a significant excess of anionic charge with charge ratios much greater than 1. When 30 wt % of the polyanion was SCNF, very little sediment was observed across all samples, even for the dispersions containing 40 or 50 wt % PEDOT-despite the fact that the overall anion/cation charge ratio was lower than the corresponding dispersions with only PSS. Similarly, the PEDOT:SCNF dispersions with 100% SCNF and no PSS in the anion showed little sedimentation for dispersions containing 29 and 40 wt % PEDOT. However, at 50 wt % PEDOT, a thick layer of grainy sediment is observed. Notably, this is the only condition tested in which the anion/cation charge ratio was below unity, being 0.77; poor dispersion stability is the expected result. A possible explanation for the fact that many of the PEDOT:PSS/SCNF dispersions appeared to show reduced settling compared to analogous PEDOT:PSS, despite the lower excess of anions, is that the surface of cellulose nanofibrils also contains significant amount of unfunctionalized hydroxyl groups that aid in dispersion.

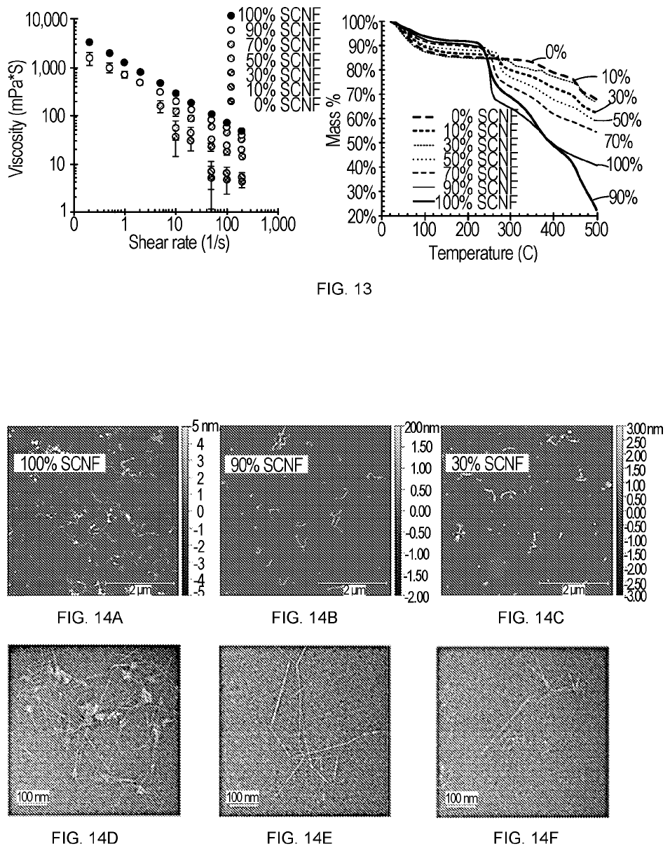

Unsurprisingly, the rheology of PEDOT:PSS/SCNF dispersions was found to display more characteristics typical of CNF as the nanofibril loading was increased. FIG. 13 reports viscosity at 0.8 wt. % (left portion) and TGA curves for (right portion) for PEDOT:PSS/SCNF dispersions with varying amounts of SCNF in the anion. All dispersions were synthesized with 29 wt. % PEDOT, corresponding to a 2.5:1 weight ratio of anion:PEDOT. As shown in the results for the left portion of FIG. 13, 100% SCNF had the greatest values, followed by 90% SCNF. Beginning at the fifth reported result through the tenth result, 70% SCNF was next. Then, beginning with the sixth reported result through the tenth result, 50% SCNF followed, then 30% SCNF followed. Finally, for the last three results, 10% SNCF and 0% SCNF followed. Specifically, higher SNF fractions led to an increase in overall viscosity coupled with stronger shear thinning behavior, as shown in FIG. 13, left portion. The thermal decomposition of PEDOT:PSS/SCNF complexes are shown in FIG. 13, right portion. As the amount of nanofibrils increased, significant decomposition developed that can be attributed to SCNF, as shown in FIG. 13, right side. One documented downside of sulfation processes is that sulfating nanocellulose is reported to compromise their thermal stability.²⁸ At higher SCNF loadings, significant loss of mass is observed at around 250° C., below the maximum temperatures at which PEDOT is resistance stable (ca. 280° C.).² This effectively reduces the viable operating temperature range of the SCNF heavy dispersions. However, at lower loadings of SCNF (i.e. 10%) the difference in TGA curves compared to pure PEDOT:PSS appears minor and occurs closer to 280−300° C.

AFM and TEM on PEDOT complexes show start differences in behavior depending on whether PSS is included in the dispersion. When no PSS is added to the system—the 100% SCNF polyanion—the 2.5:1 SCNF:PEDOT complex (i.e., containing 29 wt % PEDOT) exhibited a string-of-beads like morphology, with individual SCNF attached to larger aggregates that are presumed to be PEDOT-rich regions, as shown in FIGS. 14a and 3. With as little as 10% PSS in the SCNF/PSS polyanions, shown in FIGS. 14b and 3, these PEDOT aggregates were no longer observed, with only nanofibrillar structures present in both AFM and TEM. In this case it stands to reason that PEDOT is instead located on the fibrillar surfaces. When 70% of the anion is PSS, as shown in FIGS. 14c and f, fibrillar structures without aggregates are also observed. TEM contrast for this sample was significantly poorer, possibly due to the large amount of PSS present interfering with uranyl acetate staining. However, AFM reveals thicker nanofibrils covered in small spherical structures. This could be an indication of PEDOT and PSS sticking to the nanofibril surfaces; this same ordering of PEDOT/PSS along fibrils has also been observed in previous work on mixing PEDOT:PSS with carboxymethylated CNF, even when mixing was carried out after polymerization, and may be responsible for the increase in conductivity of PEDOT:PSS/SCNF at low SCNF loadings.²⁰

### Example 9: Conductivity of PEDOT:PSS/SNF Complexes

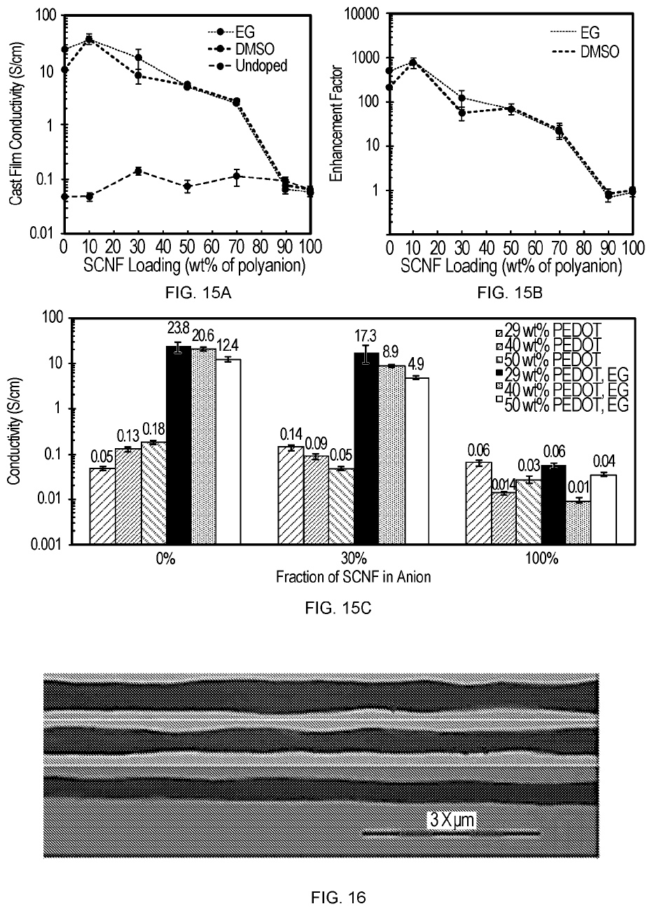

Pure PEDOT:PSS films made with 29 wt % PEDOT-corresponding to a 2.5:1 mass ratio of polyanion to PEDOT-exhibited a conductivity of 0.048 S/cm without any secondary doping. This conductivity remained unchanged when SCNF replaced 10 wt % of the anion, but increased at higher replacements of 30 through 100% SCNF of 30% through 100%. FIG. 15 reports the conductivity of PEDOT complexes with PSS, SCNF, or a combination thereof as the host polyelectrolyte (a). Conductivity of cast films with varying anion composition and secondary doping (b). Enhancement factor of secondary dopants (c). Effect of increased PEDOT fraction on cast film conductivity with and without secondary doping. The highest conductivity of 0.140 S/cm was observed at 30% SCNF replacement; a nearly 3-fold increase over the pure PEDOT:PSS. (FIG. 15a). When secondary dopants were used-EG and DMSO in this case—a different picture emerged. Applying either compound to PEDOT:PSS increased conductivity by more than two orders of magnitude (FIG. 15b), to 23.8 S/cm and 10.0 S/cm for EG and DMSO, respectively. This falls in line with the enhancement factors that have been reported previously.¹³ EG was found to give slightly higher conductivities than DMSO in many cases, although the difference was often small. Notably, PEDOT:PSS/SCNF with 10% SCNF loading was found to give a higher conductivity than PEDOT:PSS—37.5 S/cm for the EG treated film, the highest conductivity of all samples tested in this work and 58% higher in conductivity than EG treated PEDOT:PSS. As SCNF loading was increased to 30% and above, the conductivity of EG and DMSO treated films steadily decreased, falling below the levels of pure PEDOT:PSS. In particular, when 90-100% of the polyanion consisted of SCNF, the enhancement factor of EG and DMSO was, within the margin of error, unity, indicating that the solvent treatment had no effect on the system. This result strongly supports the notion that the mechanism behind secondary doping acts on the PSS in the system, rather than having a direct effect on the PEDOT. Because of how dramatically secondary doping improves PEDOT:PSS dispersions, an important ramification of this result is that any attempt to maximize conductivity of a hybrid PEDOT:PSS/SCNF complex must necessarily utilize small amounts of SCNF so as to avoid quenching the effects of secondary doping. It can be postulated that this same principle applies to some of the other works published that utilize similar strategies, though often the use of secondary dopants is not reported, so a broad generalization is difficult to make.

The conductivity of films created from dispersions with increasing 29, 40, or 50 wt % PEDOT and 0, 30, and 100% SCNF loading in the polyanion were studied with and without EG treatment (FIG. 15c, reported in order from left to right); these are the same dispersions pictured in FIG. 12. Without doping nor SCNF, the PEDOT:PSS controls showed a nearly fourfold increase in conductivity as the amount of PEDOT was increased from 29 to 50%. The opposite trend was observed for the 30% SCNF samples, with conductivity of the 50% PEDOT dispersion being ⅔ lower than at 29% PEDOT. When treated with EG, both the 0 and 30% SCNF showed diminishing conductivity as the amount of PEDOT in the dispersion was increased. The dispersions made with 100% SCNF in the polyanion showed no clear trend, with more variability between samples, particularly those with more PEDOT; possibly a result of increased heterogeneity, as these dispersions appeared somewhat grainy (FIG. 12). Regardless of the amount of PEDOT, EG treatment yielded no substantial changes in conductivity. What these results further emphasize is that PEDOT:PSS, PEDOT:PSS/SCNF, and all other dispersions based off of PEDOT polyelectrolyte complexes lead to heterogeneous materials whose conductivity is complex and depends heavily on supramolecular ordering, morphology, and other factors beyond polymeric chain structure and doping level.

Hybrid polyelectrolyte complexes of cationic PEDOT were synthesized by polymerizing the EDOT monomer in the presence of varying amounts of anionic PSS and SCNF. SCNF with a surface charge of 1.8 mmol/g was found to be able to stably disperse PEDOT on its own. The inclusion of SCNF into PEDOT dispersions led to increased base conductivity, up to a threefold increase with 30% SCNF in the PSS/SCNF polyanion mixture. Upon doping with ethylene glycol, films from PEDOT synthesized with 10% SCNF along with PSS polyanions had significantly higher conductivities of 37.5 S/cm, more than two order of magnitude increased conductivity from undoped, and 58% higher than doped PEDOT synthesized with PSS alone.

The application of cellulose nanofibrils as a means of increasing the conductivity of PEDOT and PEDOT dispersions has been examined several times, but the effect of secondary doping has largely been ignored. While the ability of functionalized nanofibrils to participate as the lone host polyelectrolyte in a polyelectrolyte complex is intriguing in and of itself, the fact that this scheme is unaffected by secondary doping renders PEDOT:SCNF complexes suboptimal on their own. Any attempt to maximize PEDOT dispersion conductivity must examine the wider picture and not hyperfocus on a singular strategy. The competing effects of secondary doping and the enhancement brought about by the inclusion of nanofibrils highlights this important fact, while also providing a route towards future development, wherein small amounts of nanofibrils can provide tangible benefits without compromising other strategies that have been employed to improve the performance of PEDOT:PSS. Judiciously employed, this technique is another tool that could help push the boundaries of what conducting polymers are capable of.

### Example 9

An aqueous PEDOT/SCNF dispersion with 2.5:1 polyanions:PEDOT ratio and 70% PSS/30% SCNF polyanion composition (i.e., ˜29 wt % PEDOT) was concentrated to 1.3 wt % for wet spinning via a 27 gauge needle (ID=210 μm) at a rate of 0.03 mL/min (linear rate of 1.4 cm/s) with a syringe pump. The spun fibers were spun into an acetone coagulation bath and air dried before being wound onto a collector. Half of the fibers were vapor treated with ethylene glycol (EG) in a closed glass container containing a dish of liquid EG at 50° C. for 24 hours. The other half were not treated. After EG treatment, both the treated and untreated fibers were cured at 120° C. for one hour before conductivity measurements and microscopy were performed.

Conductivity was measured using the two-point probe method by anchoring fibers of known diameter between two dots of conductive epoxy spaced 1 cm apart and measuring the resistance between the electrodes. This resistance was converted to conductivity with the equation a=L/(A*R), where L is the length of the fiber between electrodes, A is the cross-sectional area, and R is the resistance

The wet spun, EG treated or not, and cured (120° C., 1 h) had diameters ranging from 10−20 μm. The conductivity of the fiber was improved from 40 S/cm to 6,150 S/cm with EG treatment, an impressive increase of over 150×! These wet spun fibers, both with and without EG vapor treatment, showed a much higher (>2 orders of magnitude) conductivity than cast films of the same dispersion, which had conductivity of 17 and 0.14 S/cm with and without EG treatment, respectively. The finding of 6,150 S/cm conductivity from PEDOT synthesized in the presence of SCNF is higher than the 2,800 S/cm (J. Mater. Chem. C, 2015, 3, 2528−2538) and 3,800 S/cm (J. Mater. Chem. A, 2019, 7, 6401−6410) values reported on commercial sourced PEDOT (Clevios PH1000). This supports the hypothesis that the high aspect ratio of 1D SCNF and their tendency to axially align during mechanical shearing (e.g. extrusion from a needle) facilitate wet spinning and alignment of PEDOT in the fiber axial direction to improve conductivity. Such shear-mediated alignment of the SCNF contributes to the fabrication of unique conductive fibers from PEDOT. Further development of fiber spinning process is ongoing to further improve fiber productivity, uniformity, strength and conductivity, etc.

The results are reported in FIG. 16, which shows Optical microscopy (400×) of wet-spun PEDOT:PSS/SCNF fibers with SCNF comprising 70 wt % of the anion and a 2.5:1 weight ratio of polyanion:PEDOT.

While the invention has been described in detail, modifications within the spirit and scope of the invention will be readily apparent to those of skill in the art. It should be understood that aspects of the invention and portions of various embodiments and various features recited above and/or in the appended claims may be combined or interchanged either in whole or in part. In the foregoing descriptions of the various embodiments, those embodiments which refer to another embodiment may be appropriately combined with other embodiments as will be appreciated by one of ordinary skill in the art. Furthermore, those of ordinary skill in the art will appreciate that the foregoing description is by way of example only, and is not intended to limit the invention. All US patents and publications cited herein are incorporated by reference in their entirety.

### REFERENCES

(1) Friedrich, J.; Heywang, G.; Werner, S.; Heinze, J.; Michael, D. Polythiophenes, Process for Their Preparation and Their Use. EP 0339340 A2, 1989.
(2) Elschner, A.; Kirchmeyer, S.; Lovenich, W.; Merker, U.; Reuter, K. PEDOT: Principles and Applications of an Intrinsically Conductive Polymer; CRC Press, 2010.
(3) Kudoh, Y.; Akami, K.; Matsuya, Y. Solid Electrolytic Capacitor with Highly Stable Conducting Polymer as a Counter Electrode. Synth. Met. 1999, 102 (1−3), 973−974. https://doi.org/10.1016/S0379−6779(98)01012−1.
(4) Nardes, A. M.; Kemerink, M.; Janssen, R. A. J.; Bastiaansen, J. A. M.; Kiggen, N. M. M.; Langeveld, B. M. W.; Van Breemen, A. J. J. M.; De Kok, M. M. Microscopic Understanding of the Anisotropic Conductivity of PEDOT:PSS Thin Films. Adv. Mater. 2007, 19 (9), 1196−1200. https://doi.org/i0.1002/adma.200602575.
(5) Padinger, F.; Brabec, C. J.; Fromherz, T.; Hummelen, J. C.; Sariciftci, N. S. Fabrication of Large Area Photovoltaic Devices Containing Various Blends of Polymer and Fullerene Derivatives by Using the Doctor Blade Technique. Opto-Electronics Rev. 2000, 8 (4), 280−283.
(6) Huang, L.; Hu, Z.; Zhang, K.; Chen, P.; Zhu, Y. Dip-Coating of Poly(3,4-Ethylenedioxythiophene):Poly(Styrenesulfonate) Anodes for Efficient Polymer Solar Cells. Thin Solid Films 2015, 578, 161−166. https://doi.org/10.1016/j.tsf.2015.02.010.
(7) Eslamian, M.; Soltani-Kordshuli, F. Development of Multiple-Droplet Drop-Casting Method for the Fabrication of Coatings and Thin Solid Films. J. Coatings Technol. Res. 2018, 15 (2), 271−280. https://doi.org/10.1007/s11998−017−9975−9.
(8) Xiong, Z.; Liu, C. Optimization of Inkjet Printed PEDOT:PSS Thin Films through Annealing Processes. Org. Electron. 2012, 13 (9), 1532−1540. https://doi.org/i0.1016/j.orgel.2012.05.005.
(9) Zhou, J.; Li, E. Q.; Li, R.; Xu, X.; Ventura, I. A.; Moussawi, A.; Anjum, D. H.; Hedhili, M. N.; Smilgies, D. M.; Lubineau, G.; Thoroddsen, S. T. Semi-Metallic, Strong and Stretchable Wet-Spun Conjugated Polymer Microfibers. J. Mater. Chem. C 2015, 3 (11), 2528−2538. https://doi.org/10.1039/c4tc02354d.
(10) MacDiarmid, A. G.; Epstein, A. J. The Concept of Secondary Doping as Applied to Polyaniline. Synth. Met. 1994, 65 (2−3), 103−116. https://doi.org/10.1016/0379-6779(94)90171−6.
(11) Döbbelin, M.; Marcilla, R.; Salsamendi, M.; Pozo-Gonzalo, C.; Carrasco, P. M.; Pomposo, J. A.; Mecerreyes, D. Influence of Ionic Liquids on the Electrical Conductivity and Morphology of PEDOT:PSS Films. Chem. Mater. 2007, 19 (9), 2147−2149. https://doi.org/10.1021/cm070398z.
(12) Fan, B.; Mei, X.; Ouyang, J. Significant Conductivity Enhancement of Conductive Poly(3,4-Ethylenedioxythiophene): Poly(Styrenesulfonate) Films by Adding Anionic Surfactants into Polymer Solution. Macromolecules 2008, 41 (16), 5971−5973. https://doi.org/10.1021/ma8012459.
(13) Ouyang, J.; Xu, Q.; Chu, C. W.; Yang, Y.; Li, G.; Shinar, J. On the Mechanism of Conductivity Enhancement in Poly(3,4-Ethylenedioxythiophene):Poly(Styrene Sulfonate) Film through Solvent Treatment. Polymer (Guildf). 2004, 45 (25), 8443−8450. https://doi.org/10.1016/j.polymer.2004.10.001.
(14) Brédas, J. L.; Streets, G. B. Polarons, Bipolaron, and Solitons in Conducting Polymers. Acc. Chem. Res 1985, 18, 309−315.
(15) Kim, J. Y.; Jung, J. H.; Lee, D. E.; Joo, J. Enhancement of Electrical Conductivity of Poly(3,4-Ethylenedioxythiophene)/Poly(4-Styrenesulfonate) by a Change of Solvents. Synth. Met. 2002, 126 (2−3), 311−316. https://doi.org/10.1016/S0379−6779(01)00576−8.
(16) Pettersson, L. A.; Ghosh, S.; Inganäs, O. Optical Anisotropy in Thin Films of Poly(3,4-Ethylenedioxythiophene)-Poly(4-Styrenesulfonate). Org. Electron. 2002, 3 (3−4), 143-148. https://doi.org/10.1016/S1566−1199(02)00051−4.
(17) Jönsson, S. K. M.; Birgerson, J.; Crispin, X.; Greczynski, G.; Osikowicz, W.; Denier van der Gon, A. W.; Salaneck, W. R.; Fahlman, M. The Effects of Solvents on the Morphology and Sheet Resistance in Poly(3,4-Ethylenedioxythiophene)-Polystyrenesulfonic Acid (PEDOT-PSS) Films. Synth. Met. 2003, 139 (1), 1−10. https://doi.org/10.1016/S0379−6779(02)01259−6.
(18) Ouyang, J.; Chu, C. W.; Chen, F. C.; Xu, Q.; Yang, Y. High-Conductivity Poly(3,4-Ethylenedioxythiophene):Poly(Styrene Sulfonate) Film and Its Application in Polymer Optoelectronic Devices. Adv. Funct. Mater. 2005, 15 (2), 203−208. https://doi.org/i0.1002/adfm.200400016.
(19) Thomas, B.; Raj, M. C.; Athira, B. K.; Rubiyah, H. M.; Joy, J.; Moores, A.; Drisko, G. L.; Sanchez, C. Nanocellulose, a Versatile Green Platform: From Biosources to Materials and Their Applications. Chemical Reviews. 2018, pp 11575−11625. https://doi.org/i0.1021/acs.chemrev.7b00627.
(20) Belaineh, D.; Andreasen, J. W.; Palisaitis, J.; Malti, A.; Hikansson, K.; Wigberg, L.; Crispin, X.; Engquist, I.; Berggren, M. Controlling the Organization of PEDOT:PSS on Cellulose Structures. ACS Appl. Polym. Mater. 2019, 1 (9), 2342−2351. https://doi.org/i0.1021/acsapm.9b00444.
(21) Zhou, J.; Hsieh, Y.-L. Conductive Polymer Protonated Nanocellulose Aerogels for Tunable and Linearly Responsive Strain Sensors. ACS Appl. Mater. Interfaces 2018, 10 (33), 27902−27910. https://doi.org/10.1021/acsami.8b10239.
(22) Feng, X.; Wang, X.; Wang, M.; Zhou, S.; Dang, C.; Zhang, C.; Chen, Y.; Qi, H. Novel PEDOT Dispersion by In-Situ Polymerization Based on Sulfated Nanocellulose. Chem. Eng. J. 2021, 418, 129533. https://doi.org/10.1016/j.cej.2021.129533.
(23) Pingrey, B.; Hsieh, Y.-L. Sulfated Cellulose Nanofibrils from Chlorosulfonic Acid Treatment and Their Wet Spinning into High-Strength Fibers. Biomacromolecules 2022, 23 (3), 1269−1277. https://doi.org/10.1021/acs.biomac.1c01505.
(24) Park, S.; Baker, J. O.; Himmel, M. E.; Parilla, P. A.; Johnson, D. K. Cellulose Crystallinity Index: Measurement Techniques and Their Impact on Interpreting Cellulase Performance. Biotechnol. Biofuels 2010, 3 (10). https://doi.org/10.1186/1754−6834−3−10.
(25) Zhang, K.; Brendler, E.; Geissler, A.; Fischer, S. Synthesis and Spectroscopic Analysis of Cellulose Sulfates with Regulable Total Degrees of Substitution and Sulfation Patterns via 13C NMR and FT Raman Spectroscopy. Polymer (Guildf). 2011, 52 (1), 26−32. https://doi.org/10. 1016/j.polymer.2010.11.017.
(26) Rembaum, A. Polyelectrolyte Complexes. J. Macromol. Sci. Part A-Chem. 1969, 3 (1), 87−99. https://doi.org/10.1080/10601326908053794.
(27) Kim, E. G.; Brédas, J. L. Electronic Evolution of Poly(3,4-Ethylenedioxythiophene) (PEDOT): From the Isolated Chain to the Pristine and Heavily Doped Crystals. J. Am. Chem. Soc. 2008, 130 (50), 16880−16889. https://doi.org/10.1021/ja806389b.
(28) Camarero Espinosa, S.; Kuhnt, T.; Foster, E. J.; Weder, C. Isolation of Thermally Stable Cellulose Nanocrystals by Phosphoric Acid Hydrolysis. Biomacromolecules 2013, 14 (4), 1223−1230. https://doi.org/10.1021/bm400219u.

1. A method for forming sulfated cellulose nanofibrils, the method comprising:
a) dispersing cellulose in a solvent to form a cellulose dispersion;
b) reacting the dispersed cellulose with chlorosulfonic acid to produce sulfated cellulose;
c) washing the sulfated cellulose to form a washed sulfated cellulose; and
d) disintegrating the sulfated cellulose to form the sulfated cellulose nanofibrils.

2. The method according to claim 1, wherein the cellulose is Cellulose I or native cellulose isolated from plant biomass selected from the group consisting of rice straw, wheat straw, sugarcane, bagasse, almond shell, corn husk, wood, bamboo, jute, hemp, sisal, and combinations thereof.

3. The method according to claim 1, wherein the reacting cellulose with chlorosulfonic acid simultaneously pretreats and functionalizes the cellulose.

4. The method according to claim 1, wherein the method further comprises:
e) wet-spinning the sulfated cellulose nanofibrils to form fibers.

5. The method according to claim 4, wherein the wet-spinning is conducted in the presence of a coagulant selected from the group consisting of acetone, ethanol, isopropanol, mixtures of calcium chloride and isopropanol, and combinations thereof.

6. The method according to claim 4, wherein the fibers are not subjected to drawing.

7. The method according to claim 1, wherein the yield of sulfated cellulose nanofibrils is at least 90%.

8. The method according to claim 1, wherein the molar ratio of chlorosulfonic acid per anhydroglucose unit is from 0.5:1 to 1.5:1.

9. The method according to claim 1, wherein the reacting occurs for one (1) to sixty (60) minutes.

10. The method according to claim 1, wherein the length of the sulfated cellulose nanofibrils is from 0.7 μm to 1.8 μm.

11. The method according to claim 1, wherein the width of the sulfated cellulose nanofibril is from 3.5 to 6 nm.

12. The method according to claim 1, wherein the height of the sulfated cellulose nanofibril is from 1.2 to 1.4 nm.

13. The method according to claim 1, wherein the length to height aspect ratio of the sulfated cellulose nanofibril is from 500:1 to 1000:1.

14. The method according to claim 1, wherein the sulfated cellulose nanofibril has a rectangular cross section with a width to height ratio from 3:1 to 4.7:1.

15. The method according to claim 1, wherein the sulfated cellulose nanofibril exhibits amphiphilicity, thixotropy, and shear thinning behaviors.

16. A wet-spun sulfated cellulose nanofibril fiber formed by the method of claim 1, the fiber having a charge from 1.0 mmol/g to 2 mmol/g.

17. A fiber of claim 16, wherein the fiber has a fiber diameter from 9 to 20 μm.

18. The fiber of claim 16, wherein the fiber has a Young's modulus from 20 to 35 GPa.

19. The fiber of claim 16, wherein the sulfated cellulose nanofibril has a tensile strength from 525 to 850 MPa.

20. The fiber of claim 16, wherein the sulfated cellulose nanofibril has a strain at break from 5 to 15%.
